(19) United States
(12) Patent Application Publication
(10) Pub. No.: US 2004/0225647 A1
(43) Pub. Date: Nov. 11, 2004

(54) Display system and method

(76) Inventors: John Connelly, Santa Cruz, CA (US); Linda Jane Bennett, New York, NY (US); Qi Lu, Saratoga, CA (US); Justin Everett-Church, Fremont, CA (US); Steven Milano, San Francisco, CA (US); David Shen, Cupertino, CA (US)

Correspondence Address: James J. DeCarlo, Stroock & Stroock & Lavan LLP, 180 Maiden Lane, New York, NY, 10038, US

(21) Appl. No.: 10/723,151

(22) Filed: Nov. 26, 2003

Related U.S. Application Data
(60) Provisional application No. 60/469,496, filed on May 9, 2003.
(60) Provisional application No. 60/515,322, filed on Oct. 28, 2003.

(51) Int. Cl. G06F 7/00

(52) U.S. Cl. 707/3

(57) ABSTRACT

Systems and methods for providing display, and, more particularly, systems and methods for monitoring and filtering data entered by Internet users to promote products and services on a display medium, such as a computer or outdoor billboard, are described. Certain embodiments of the invention include receiving search queries from multiple users, filtering the search queries based on one or more filtering criteria, and initiating display of filtered search queries to viewers, the viewers remote from the users.

### CROSS-REFERENCE TO RELATED APPLICATIONS

This Application claims the benefit of U.S. Provisional Application Serial No. 60/469,496, filed on May 9, 2003, entitled SYSTEM AND METHOD OF OUTDOOR ADVERTISING, and U.S. Provisional Application Serial No. 60/515,322, filed on October 28, 2003, entitled DISPLAY SYSTEM AND METHOD, both of which are hereby incorporated by reference.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. BACKGROUND OF THE INVENTION

1. Field of the Invention

The present invention relates generally to display media, and promotion and advertising, and, to a system and method for monitoring and filtering data entered by Internet users for display on a display medium, such as a computer or outdoor billboard or other perceptible medium.

2. Description of Related Art

Advertising through use of the Internet and World Wide Web has become increasingly popular as a way to promote products and services to consumers. Many advertisers have found that advertising their products and services over the Internet can be very productive and beneficial. This use of the Internet to advertise products and services often takes the form of banner ads, pop-up ads, interstitials, frame ads, and the like. When accessing or “surfing” the web, an Internet user will typically encounter various advertisements, based on his preferences, as identified in his on-line user profile, or based on previous surfing habits. However, the effectiveness of such advertisements has been called into question recently. Furthermore, a user's data is typically used in a relatively limited way, namely to provide advertisements to only that user through the aforementioned on-line advertisements. As such, a vast amount of data relating to Internet users remains largely under-utilized. Accordingly, a need exists for a method and system that better utilizes user data for presentment.

### SUMMARY OF THE INVENTION

The foregoing as well as other needs are satisfied by the present invention. According to certain embodiments, methods and systems of displaying selected data entered by users are disclosed.

One embodiment of the invention is directed to a method of providing a display. The method in this embodiment includes receiving search queries from multiple users, filtering the search queries based on one or more filtering criteria, and initiating display of filtered search queries to viewers, the viewers remote from the users.

Another embodiment of the invention is directed to a method for displaying data based on user input. The method in this embodiment includes receiving user input from multiple users via an on-line application, automatically selecting received user input for display based on filtering criteria, and facilitating display of data based on the selected user input to users.

Yet another embodiment of the invention is directed to a client-server system for displaying data based on user input. The system in this embodiment includes one or more user interfaces to receive user input, a monitoring web server communicatively coupled to the user interface, the monitoring web server configured to select received user input for display based on first filtering criteria, a select search server communicatively coupled to the monitoring web server and the flash server, the select search server configured to select received user input for display based on second filtering criteria, and a visual display server communicatively coupled to the select search server, the advertisement server configured to initiate display of data based on the selected user input via one or more files on a web page.

Other embodiments and features are further described herein. The invention will next be described in connection with certain exemplary, non-limiting embodiments; however, it should be clear to those skilled in the art and from the teachings herein that various modifications, additions, and subtractions can be made without departing from the spirit or scope of the claims, which set forth the scope of the invention.

### BRIEF DESCRIPTION OF THE DRAWINGS

The following drawing figures, which are included herewith and form a part of this application, are intended to be illustrative examples and not limiting of the scope of the present invention.

FIG. 1 is a workflow diagram illustrating the components and flow of data according to one embodiment of the present invention.

FIG. 2 is a flowchart illustrating the process for monitoring search queries according to one embodiment of the present invention.

FIG. 3 is a flowchart illustrating the process for first content filtering according to one embodiment of the present invention

FIG. 4 is a flowchart illustrating the process for reading information from the monitoring web server and writing information to the select search server according to one embodiment of the present invention.

FIG. 5 is a flowchart illustrating the process for second content filtering according to one embodiment of the present invention.

FIG. 6 is a flowchart illustrating the process for demographic filtering according to one embodiment of the present invention.

FIG. 7 is a flowchart illustrating the process for spam filtering according to one embodiment of the present invention.

FIG. 8 is a flowchart illustrating the process for selecting and displaying search queries on the visual display device according to one embodiment of the present invention.

FIGS. 9a-c are exemplary advertisements on a web page, incorporating scrolling filtered search queries according to certain embodiments of the present invention.

FIGS. 10-14 illustrate exemplary computer software that may be used to implement the advertisement of FIG. 9a according to one embodiment of the present invention.

FIGS. 15-17 are exemplary visual display devices according to certain embodiments of the present invention.

FIGS. 18 and 19 are further exemplary visual display devices according to additional embodiments of the present invention.

### DETAILED DESCRIPTION OF CERTAIN EMBODIMENTS

Certain exemplary embodiments of the present invention will now be described in greater detail with reference to the aforementioned figures.

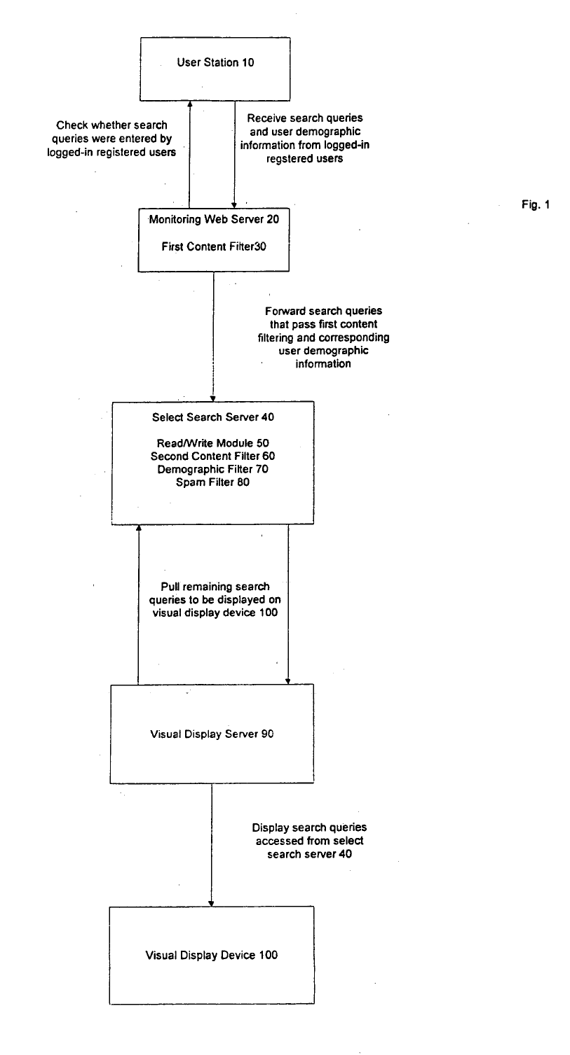

FIG. 1 is a workflow diagram illustrating the components and flow of data according to one embodiment of the present invention. This embodiment of the invention includes: a user station 10, a monitoring web server 20, a first content filter 30, a select search server 40, a read/write module 50, a second content filter 60, a demographic filter 70, a spam filter 80, a visual display server 90 and a visual display device 100.

In the presently described embodiment, the monitoring web server 20 is a computing device or processor, communicatively coupled to one or more user stations 10 and the select search server 40, via any of a number of networks, such as a local area network, wide area network, the Internet, wireless network, satellite transmission, virtual private network and the like, utilizing essentially any type of communication protocol, such as Ethernet, IP addressing, transmission via data packets and the like. The monitoring web server 20 functions automatically to perform certain tasks, such as monitoring and retrieving search queries entered by users to a search engine at one or more user stations 10, retrieve available user demographic information for the user that entered a search query, and/or forward search queries and the corresponding user demographic information to one or more filters that remove certain search queries in accordance with desired predetermined filtering criteria. It is to be understood by those skilled in the art that a search term includes, but is not limited to, words and phrases. Additionally a search query includes, but is not limited to one or more words and/or phrases and/or characters or symbols used to facilitate a search, such as “and”, “+”, “!”, “*”. The following are exemplary filters in the presently described embodiment.

The first content filter 30 is preferably a software object or program running on the monitoring web server 20 that functions automatically to remove search queries containing search terms found in a “bad words” hash table. The first content filter 30 forwards to the select search server 40 each remaining search query and the corresponding user demographic information.

The select search server 40 is a computing device or processor communicatively coupled to one or more monitoring web servers 20 by any one of the above-mentioned networks, type of protocols, and the like. The select search server 40 receives each remaining search query and corresponding user demographic information, after the filtering process has been completed.

The read/write module 50 is preferably a software object or program running on the select search server 40 that reads each search query and the corresponding user demographic information received from the first content filter 30 and writes the search query and corresponding user demographic information to one or more files.

The second content filter 60 is preferably a software object or program running on the select search server 40 that reads the files from the read/write module 50 and removes search queries that contain search terms and phrases found in a “bad phrases” hash table. The second content filter 60 stores the remaining search queries and corresponding user demographic information in memory.

The demographic filter 70 is preferably a software object or program running on the select search server 40 that reads the remaining search queries and corresponding user demographic information in memory and removes search queries having corresponding user demographic information that does not match the demographic fields found in a “desired demographics” hash table. The demographic filter 70 stores the remaining search queries and corresponding user demographic information in memory.

The spam filter 80 is a software object or program running on the select search server 40 that reads the remaining search queries and corresponding user demographic information stored in memory and removes search queries that flood the system with repetitive, inappropriate searches, frequently referred to as “spam”. The spam filter 80 writes the remaining search queries and the corresponding user demographic information to a file and forwards the files to the select search server 40.

The visual display server 90 is a computing device or processor communicatively coupled to the select search server 40 and the visual display device 100 by any one of the above-mentioned networks, protocol types, and the like. The visual display server 90 pulls and receives remaining search queries from the select search server 40 and displays the search queries on a visual display device 100, such as a computer, video screen, or stationary or mobile video billboard.

Having generally described the components of the present embodiment, each component will now be described in greater detail. As illustrated, the user station 10 is a computing device or processor, such as a personal computer (PC), personal digital assistant (PDA), web-enabled cellular telephone, and the like. Furthermore, each user station 10 preferably includes a graphical user interface that is capable of displaying an Internet browser, such as that offered by Microsoft Corporation under the tradename INTERNET EXPLORER. A search engine offered by a system provider, such as that offered by Yahoo! Inc. under the tradename YAHOO! SEARCH provides an Internet-accessible search service that enables a user to enter search queries, via a graphical user interface presented on the user station 10 via a web browser, to search for information on the Internet.

As an initial matter, users may register with the system provider of the search engine, such as that offered by Yahoo! Inc. under the tradename YAHOO!. In general, such registration includes prompting the user to provide the system provider with information by requiring the user to enter a plurality of information fields, including user demographic information fields (such as home address, work address, telephone number, email address, gender, ethnicity, birth date, job description, or any other user input data).

In one embodiment, the user provides the above-mentioned information via a secure web page generated by the system provider of the search engine. The system provider receives the information via the Internet and electronically writes and stores the information via a local area network to an account database. In an alternate embodiment, the user manually provides the information to the system provider, where an employee of the system provider, in turn, manually enters the information into an account database. In either embodiment, once the system provider receives the account information fields and the user demographic information fields, a user ID is assigned to the user and the corresponding record in the database is populated.

The monitoring web server 20 is a computing device or processor, communicatively coupled to one or more user stations 10 and the select search server 40, via any of a number of networks, such as a local area network, wide area network, the Internet, wireless network, virtual private network and the like, utilizing essentially any type of communication protocol, such as Ethernet, IP addressing, transmission via data packets and the like. The monitoring web server 20 functions automatically to monitor search queries entered by logged-in registered users to a search engine at one or more user stations 10. When a registered user enters his or her user ID and password to the system provider of the search engine at the user station 10, the monitoring web server 20 generates a cookie that is sent to the user station 10. All subsequent information transmitted from the user station 10 to the monitoring web server 20 will include this cookie information, which includes the user ID and user's demographic information.

When a registered user enters a search query at the user station 10, the search query, along with the user's cookie information (including user's user demographic information and IP address of user's user station 10), is sent to the monitoring web server 20. The monitoring web server 20 is able to determine whether the user entering the search query is a logged-in registered user by the presence of the cookie. Where the monitoring web server 20 determines that a search query has been entered by a logged-in registered user, the search query and the corresponding user's user demographic information, as contained in the cookie, are written to a log file and forwarded to the first content filter 30. In alternate embodiments, the user station 10 or the monitoring web server 20 may be coupled to an account database, which stores information for users that have registered with the service provider. This account database may be accessed by either the user station 10 or the monitoring web server 20 to retrieve the corresponding user demographic information for the registered user that has entered a search query.

The first content filter 30 is a software object or program, running on the monitoring web server 20. The first content filter 30 receives log files containing search queries and the corresponding user demographic information and IP address from the monitoring web server 20. The first content filter 30 compares the search terms in each search query received from the web monitoring server 20 with a list of words contained in a “bad words” hash table.

The “bad words” hash table is preferably a file, such as a simple configuration file, stored with or as part of the first content filter 30 or associated memory that contains a list of words, one per line, that are considered to be undesirable to display to the public. The “bad words” hash table may also include words that are likely to display search results that are considered undesirable to display to the public. In addition, each word has a configurable list of suffixes added to cover common pluralizations and inflections. Preferably, an administrator of the system provider is provided access to add, revise, and remove words contained in the “bad words” hash table, without having to make changes to the software object or program code, to allow the system provider to adapt to changes in public culture and advertising strategies. Changes to the “bad words” hash table are generally realized upon server startup, but in alternate embodiments, changes to the “bad words” hash table could be realized immediately upon revisions by the administrator, as a matter of design choice.

The first content filter 30 removes the entire search query if any words contained in the “bad words” hash table are found in the search query. This process will be described in more detail later herein. The first content filter 30 splits each remaining search query and the corresponding user demographic information and IP address into component pieces, and forwards these component pieces, such as UDP packets, to the select search server 40.

The select search server 40 is a computing device or processor communicatively coupled to one or more monitoring web servers 20 by any one of the above-mentioned networks, type of protocols, and the like. The select search server 40 also receives files containing each remaining search query and the corresponding user demographic information and IP address after the filtering process has been completed. The select search server 40 writes each remaining search query to a file, such as an HTML file, that can be accessed by the visual display server 90 to be displayed on the visual display device 100.

The read/write module 50 is preferably a software object or program, running on the select search server 40. The read/write module 50 reads the search query and the corresponding user demographic information and IP received from the first content filter 30. The read/write module 50 writes each search query and corresponding user demographic information and IP address to a file, such as a stream log file.

The second content filter 60 is preferably a software object or program, running on the select search server 40. The second content filter 60 reads each file (containing a search query and corresponding user demographic information and IP address) written by the read/write module 50. The second content filter 60 compares the search terms in the search query for the current stream log file with a list of words and phrases contained in a “bad phrases” hash table.

The “bad phrases” hash table is a file, such as a simple configuration file, stored in the second content filter 60 or associated memory that contains a list of phrases that are considered to be undesirable to display to the public. The “bad phrases” hash table may also include phrases that are likely to display search results that are considered undesirable to display to the public. Each entry in the “bad phrases” hash table may indicate one or more character strings and logical operators. For example, in the present embodiment, each “bad phrase” is comprised of a string of characters, and flags specifying whether that character string must match the search query (a) exactly, (b) only at the beginning word of the search query, or (c) anywhere in the given search query. Preferably, an administrator of the system is provided access to add, revise, and remove the phrases contained in the “bad phrases” hash table, without having to make changes to the software object or program code, to allow the provider of the system to adapt to changes in public culture and advertising strategies. Changes to the “bad phrases” hash table are generally realized upon server startup, but in alternate embodiments, changes to the “bad phrases” hash table could be realized immediately upon revisions by the administrator, as a matter of design choice.

The second content filter 60 removes an entire search query where any of the phrases contained in the “bad phrases” hash table match the search query. This process will be described in more detail herein. The second content filter 60 stores the remaining search queries and corresponding user demographic information in memory. In the present embodiment, the search queries and corresponding user demographic information remaining after each filtering step are kept or identified in memory and then received by the next filter. In alternate embodiments, the remaining search queries and the corresponding user demographic information and IP address could be written to a file and forwarded from one filter to the next filter or forwarded via any type of network communication.

The demographic filter 70 is preferably a software object or program running on the select search server 40. The demographic filter 70 reads the remaining search queries stored in memory, along with the user demographic information and IP address corresponding to the user that entered each search query. The demographic filter 70 compares the corresponding user demographic information for the current search query with a list of demographic fields contained in the “desired demographics” hash table. The demographic filter 70 removes and discards the current search query, unless the corresponding user demographic information for the registered user is equal to or contained within the range for the field contained in the “desired demographics” hash table, although in alternate embodiments the query is not removed based on the demographics. The demographic filter 70 stores the remaining search queries and corresponding user demographic information and IP address in memory. This process will be described in more detail herein. In alternate embodiments, the search queries will be directly written to a file, such as an HTML or XML file, for display in an advertisement, whereby a further process may be used to filter the search queries for display based upon demographics, as described later in this application.

The “desired demographics” hash table is a file, such as a simple configuration file, stored in the demographic filter 70 or associated memory that contains a list of fields corresponding to the demographic fields entered by a registered user at the time of registration or updated thereafter with the system provider. Such fields may include geographic information (e.g. state, country, or zip code), age range, gender, certain websurfing history and other information that can be collected or identified. The list of fields in the “desired demographics” hash table represent the demographics of registered users for which the system provider wishes to display search queries to the public. Preferably, an administrator of the system is provided access to add, revise, and remove fields contained in the “desired demographics” hash table, without having to make changes to the software object or program code, to allow the system provider to continuously adapt their advertising and marketing strategies and to focus these strategies on different consumers. Changes to the “desired demographics” hash table are generally realized upon server startup, but in alternate embodiments, changes to the “desired demographics” hash table could be realized immediately upon revisions by the administrator, as a matter of design choice.

For example, the system provider may seek to display search queries from persons living in a particular country of a certain age. Therefore, an administrator of the system provider would access the “desired demographics” hash table and list the particular country, such as “Japan”, in the demographic field “Country”, and the particular age “35” in the demographic field “Age”. Accordingly, the demographic filter 70 will remove a search query unless the corresponding user demographic information for the registered user who entered that search query has “Japan” listed in the demographic field “Country” and “35” listed in the demographic field “Age”.

The spam filter 80 is preferably a software object or program, running on the select search server 40. The spam filter 80 reads the search queries remaining after the previous filters and corresponding user demographic information stored in memory. The spam filter 80 combines the current search query and the corresponding user's ID and IP address to form a key. The spam filter compares this key with a list of keys contained in an “in-memory” hash table to determine whether the key has previously been stored in the “in-memory” hash table. The “in-memory” hash table is a file, such as a simple configuration file, accessible to the spam filter that contains a list of previously stored keys. The spam filter 80 removes an entire search query where the key already exists in the “in-memory” hash table, thereby ensuring that a single person with one user ID or IP address cannot “spam” the system by repeatedly reloading a specific search term. Additionally, the spam filter 80 removes any search queries entered by users that have registered with the system provider within the last 14 days. This prevents people from creating many new accounts with the system provider and then spamming the system using those newly-created accounts. This process will be described in more detail herein. The spam filter 80 writes each remaining search query and the corresponding user demographic information and IP address to a file and forwards the files to the select search server 40. Changes to the “in-memory” hash table are generally realized upon server startup, but in alternate embodiments, changes to the “in-memory” hash table could be realized immediately upon revisions by the administrator, as a matter of design choice.

The visual display server 90 is a computing device or processor or software communicatively coupled to the select search server 40 and the visual display device 100 by any one of the above-mentioned networks, protocol types, and the like. The visual display server 90 pulls and receives remaining search queries from the select search server 40 and initiates, facilitates or directly causes the display of the search queries to be perceptibly displayed on a visual display device 100, such as a computer, video screen, stationary or mobile video billboard or in a scrolling video or advertisement on a web page.

It should be understood that description of the hash tables of the present embodiment is merely an illustrative logical arrangement of exemplary data and filtering criteria, as more or less data may be stored in different embodiments, and such data may be arranged in fewer or more tables, databases or files. In alternate embodiments, one or more of the “bad words”, “bad phrases”, “desired demographics”, and “in-memory” hash tables could be stored in one or more databases or other memory, as part of one or more of the aforementioned components or a separate component. Any of the one or more databases could be accessible, via a communicative coupling, to any of the aforementioned components of the present embodiment.

Having described exemplary components of the present embodiment, the operation thereof will now be described in greater detail.

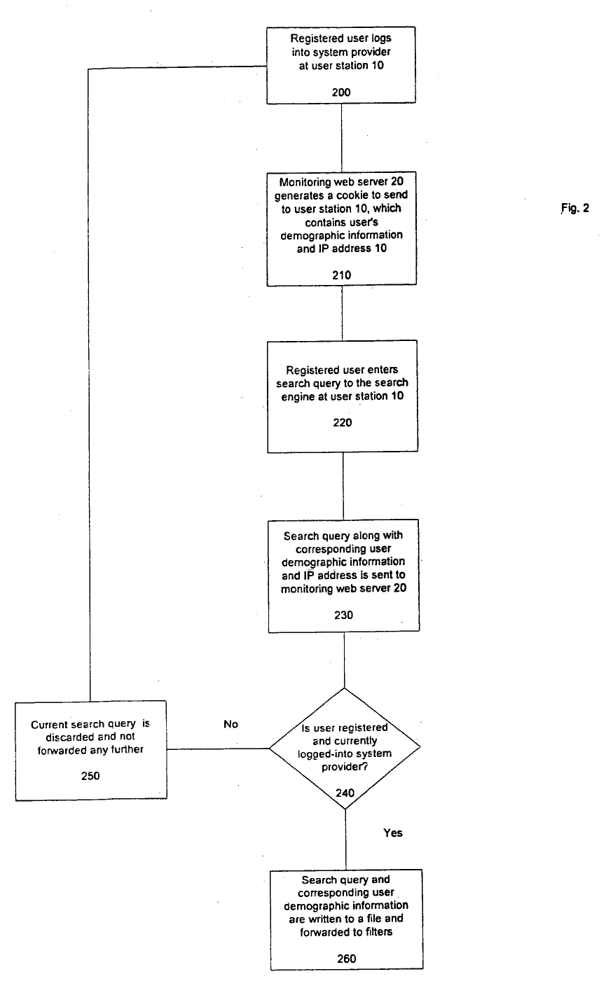

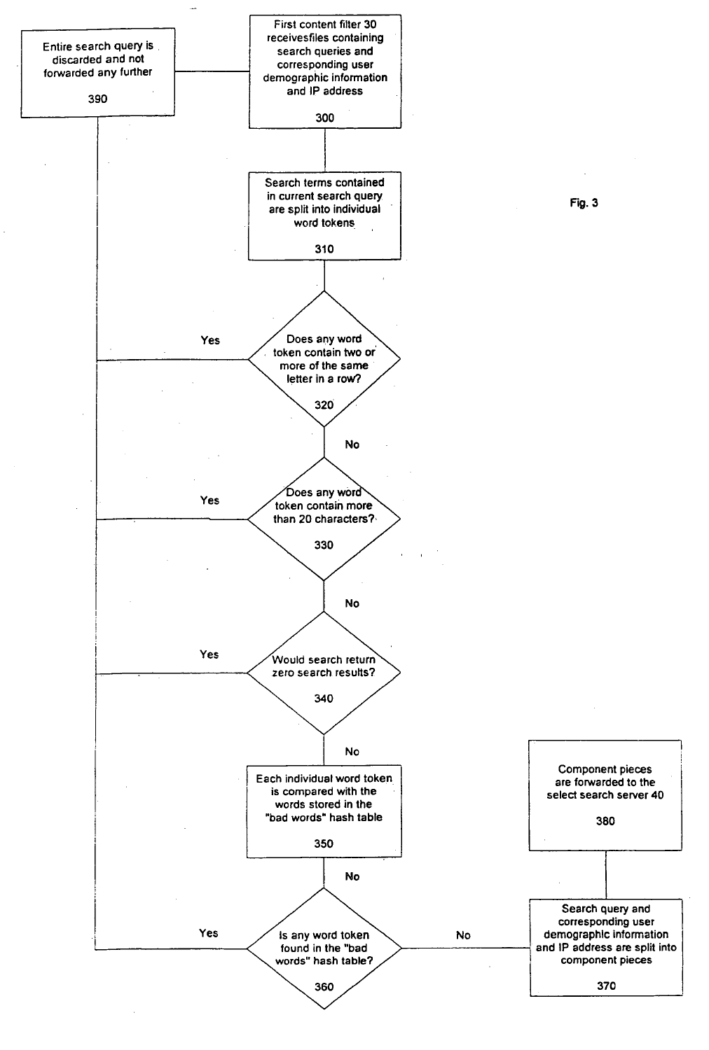

A process for monitoring search queries according to one embodiment of the present invention will now be described with reference to FIG. 2.

In step 200, a registered user logs into the system provider at a user station 10 by entering a previously stored user ID and password via a web page of the system provider at the user station 20. In step 210, the monitoring web server 20 generates a cookie that is sent to the user station 10. All subsequent information transmitted from the user station 10 to the monitoring web server 20 will include this cookie information, which includes the user's demographic information (including user's ID) and IP address of the user's user station 10. In step 220, the registered user enters a search query to the search engine via a web page of the system provider at the user station 10. In step 230, the search query along with the user's cookie information is sent to the monitoring web server 20 to allow the monitoring web server 20 to determine whether a registered logged-in user has entered the search query. The monitoring web server 20 is able to determine whether the user entering the search query is a logged-in registered user by the presence of the cookie. If the monitoring web server 20 determines that the user entering the search query is not currently registered and logged-into the system provider, in step 240, the search query is disregarded and not forwarded any further, in step 250. The system then proceeds to evaluate another user. If the monitoring web server 20 determines that the user entering the search query is currently registered and logged-into the system provider, in step 240, the search query and the corresponding user's user demographic information and IP address are written to a log file and forwarded to filters, in step 260.

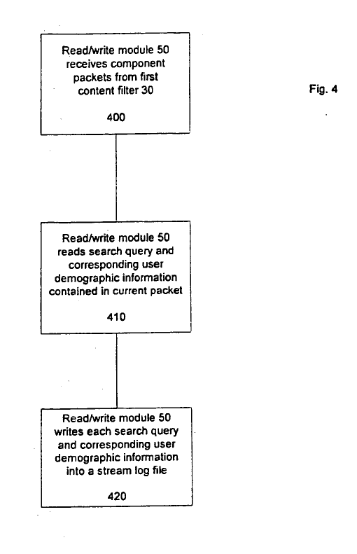

A process for first content filtering according to one embodiment of the present invention will now be described with reference to FIG. 3.

In step 300, the first content filter 30 receives log files containing search queries and their corresponding user demographic information and IP address from the monitoring web server 20. In step 310, the search terms contained in the current search query are split into individual word tokens (lowercases for all letters). Having broken the query into word tokens, the first content filter 30 proceeds to identify for removal certain word tokens identified, as a matter of design choice. Thus, for example, in step 320, where any word token contains two or more of the same letter in a row, the entire current search query is disregarded and not forwarded any further, in step 390. In step 330, where any individual word token contains more than 20 characters, the entire current search query is disregarded and not forwarded any further, in step 390. In step 340, where zero results would be returned by the search engine, the entire current search query is disregarded and not forwarded any further, in step 390. In step 350, each individual word token in a remaining current search query is compared with a list of words contained in the “bad words” hash table. If any individual word token in the current search query is found within the “bad words” hash table, in step 360, the entire search query is disregarded and not forwarded any further, in step 390. If no individual word token in the current search query is found within the “bad words” hash table, in step 360, the current search query and the corresponding user demographic information and IP address are split into component pieces, in step 370. In step 380, the component pieces are forwarded (for example, via UDP packets) to the select search server 40.

For example, a user enters the search query “porn pictures” into the search box of a web browser or search engine on the user station 10. When the user clicks the “Search” button, the search query is sent to the monitoring web server 20. The user's demographic information and IP address is also sent at the same time in or with a cookie. The monitoring web server 20 processes the search request, returns search results to the user station 10, and logs the search query “porn pictures”, user demographic information for the user, and other information about the search request, including the IP address of the user station 10 into a log file. The first content filter 30 reads the search query “porn pictures” from the log file along with the user demographic information and IP address. The first content filter 30 splits the search query “porn pictures” into two individual word tokens: “porn” and “pictures”, and then compares each word token: “porn” and “pictures” to a set of words in the “bad words” hash table. In this example, the “bad words” hash table was pre-populated to contain the word “porn”, as well as “porno” and “pornography”. Since the word “porn” was found in the “bad words” hash table, the first content filter 30 rejects the search query “porn pictures” and does not forward the search query to the select search server 40.

A process for reading information from the monitoring web server 20 and writing information to select search server 60 according to one embodiment of the present invention will now be described with reference to FIG. 4.

In step 400, the read/write module 50 receives the component pieces, namely search query, demographics and IP address, forwarded from the first content filter 30. In step 410, the read/write module 50 reads the current search query and the corresponding user demographic information and IP address. In step 420, the read/write module 50 writes each search query and the corresponding user demographic information and IP address into a stream log file. Although a single file or memory location could be used, in the present embodiment, a new stream log file is started after a certain amount of time or after the existing file reaches a certain size, and the previous file is closed and forwarded to the select search server 40. The present embodiment creates a new file every five minutes. This enables the second content filter 60, the demographic filter 70 and the spam filter 80 to receive search queries in five minute intervals (search query was received within the last 5, 10, 15, 20, etc. minutes). In alternate embodiments, these intervals may be greater than or less than 5 minutes.

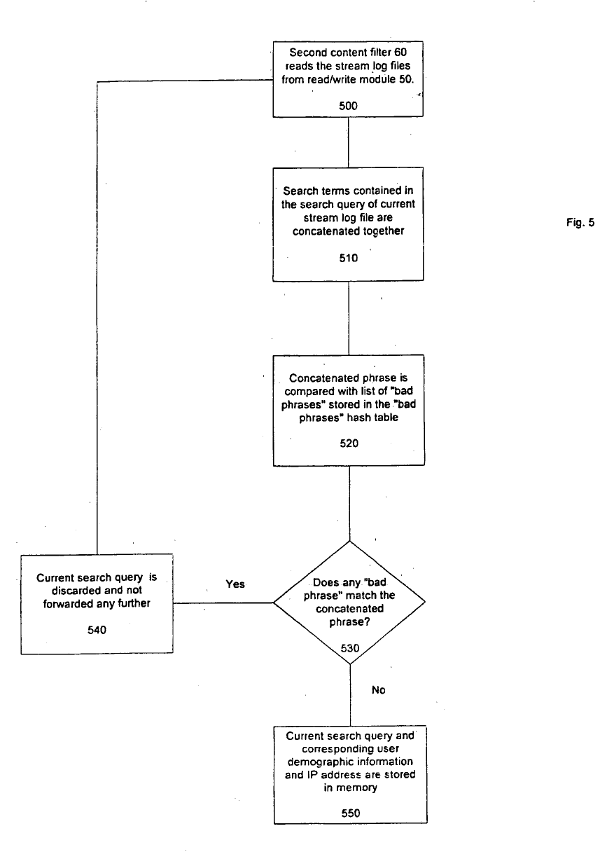

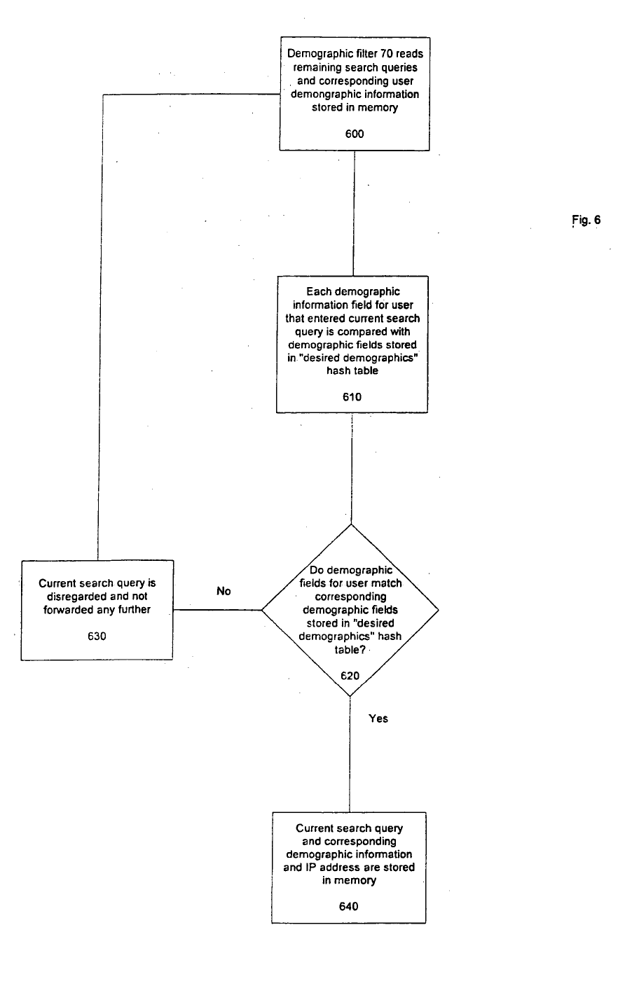

A process for second content filtering according to one embodiment of the present invention will now be described with reference to FIG. 5.

In step 500, the second content filter 60 reads the stream log files (each containing a search query and corresponding user demographic information and IP address) from the read/write module 50. In step 510, the search terms contained in the search query of the current stream log file are concatenated together by eliminating all non-alphanumeric characters and lowercasing all remaining characters. For example: “President George Bush” becomes “presidentgeorgebush”. In this step, a separate array is created that specifies, for each character position, if that character was preceded and/or followed by a non-alphanumeric character in the original phrase. In step 520, the concatenated phrase is compared with a list of “bad phrases” contained in the “bad phrases” hash table. Each “bad phrase” is comprised of a string of characters, and flags specifying whether a character string in the “bad phrase” must match the concatenated phrase (a) exactly, (b) only at the beginning or end of a concatenated phrase, (c) anywhere in the given concatenated phrase, or any other specification chosen by the system provider. An exemplary “bad phrase” contained in the “bad phrases” hash table may be “bush”, with flags specifying that this string must match exactly (i.e. “bush” is bad, but “ambush” is acceptable, as is “bushes”). If the concatenated phrase is deemed to include any of the “bad phrases”, in step 530, the entire search query (corresponding to the concatenated phrase) is disregarded and not forwarded any further, in step 540. If the concatenated phrase does not match any of the list of “bad phrases” in the “bad phrases” hash table, in step 530, the current search query (corresponding to the concatenated phrase) and the corresponding user demographic information and IP address are stored in memory, in step 550.

For example, a user enters the search query “p o r n o” (with the letters separated by spaces) into the search box of the web browser on the user station 10. When the user clicks the “Search” button, the search query is sent to the monitoring web server 20. The user's demographic information and IP address is also sent at the same time in or with a cookie. The monitoring web server 20 processes the search request, returns search results to the user station 10, and logs the search query “p o r n o”, user demographic information relating to the user, and other information about the search request, including the IP address of the user station 10 in a log file. The first content filter 30 reads the terms from the file along with the user demographic information and IP address. The first content filter 30 splits the search query into five individual word tokens: “p”, “0”, “r”, “n”, and “o”. The first content filter 30 then looks for each these five word tokens in the “bad words” hash table. Since none of the word tokens are in the “bad words” hash table, the first content filter 30 forwards the original search query (“p o r n o”), user demographic information, and IP address, via UDP packets, to the select search server 40.

The read/write module 50 receives the UDP packets forwarded from the first content filter 30 and reads the search query “p o r n o”, corresponding user demographic, information, and IP address contained in the current UDP packet. The read/write module 50 writes the search query “p o r n o”, corresponding user demographic information, and IP address into a stream log file.

The second content filter 60, running on the select search server 40, reads the stream log file containing the search query “p o r n o”, corresponding user demographic information, and IP address from the read/write module 50. The second content filter 60 then scrunches the search terms in the search query “p o r n o”, removing any non-alphanumeric characters, resulting in the concatenated phrase “porno”. The concatenated phrase “porno” is then compared with each bad phrase in the “bad phrases” hash table. In this example, one of the bad phrases in the “bad phrases” hash table is “porn”, with a flag specifying that this bad phrase must match at the beginning or end of a concatenated phrase. Since “porn” is a substring of “porno” and is found at the beginning of the concatenated phrase “porno”, the second content filter 60 does not forward the search query “p o r n o” any further. Additionally, a search query for “m o r e p o r n” would be concatenated to “moreporn” and removed since “porn” is found at the end of the concatenated phrase. However, the word “epornithology”, the study of disease in bird communities, would not be removed since “porn” is not found at the beginning or end of the search query (specified by the flag as necessary for removal in the current example).

A process for demographic filtering according to one embodiment of the present invention will now be described with reference to FIG. 6.

In step 600, the demographic filter 70 reads the search queries (remaining after the first and second content filtering processes) and corresponding user demographic information and IP address stored in memory by the second content filter 60. In step 610, the demographic filter 70 compares each user demographic information field for the user that entered the current search query with the list of demographic fields contained in the “desired demographics” hash table. If the user demographic information fields for the user submitting the query do not match the corresponding demographic fields stored in the “desired demographics” hash table, as determined in step 620, the current search query is disregarded and not forwarded any further, in step 630. If the user demographic information fields for the user match the corresponding demographic fields stored in the “desired demographics” hash table, in step 620, the current search query and the corresponding user demographic information and IP address are stored in memory, in step 640.

For example, a user enters the search query “britney spears” as described above. This search query passes successfully through both the first content filter 30 and second content filter 60 and is passed to the demographic filter 70, along with the user's corresponding user demographic information: (e.g., a female, 22 years old, and from zip code 95060) and IP address of the user's user station 10. In this illustrative example, the “desired demographics” hash table requires: any gender, ages 25-35, and from any location. Since age 22 is not within the desired age range 25-35, the search query “britney spears” would not be forwarded any further in this example.

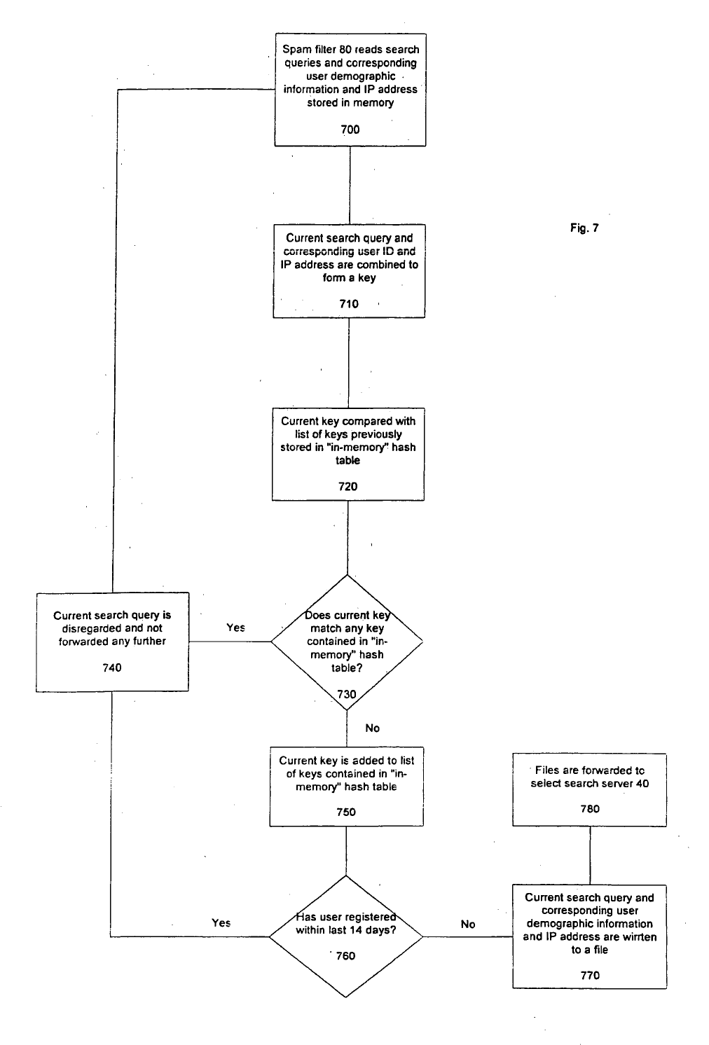

A process for spam filtering according to one embodiment of the present invention will now be described with reference to FIG. 7.

In step 700, the spam filter 80 reads the search queries and corresponding user demographic information and IP address stored in memory by the demographic filter 70. In step 710, the current search query and the corresponding user's ID and IP address are combined to form a key. This combining can be performed in any number of ways, such as using a hash algorithm or other cryptographic technique. In step 720, the spam filter 80 compares this current key with a list of keys previously stored in the “in-memory” hash table. If the current key matches any of the keys contained in the “in-memory” hash table, in step 730, the search query corresponding to the current key is disregarded and not forwarded any further, in step 740. If the current key does not match the any of the keys contained in the “in-memory” hash table, in step 730, the current key is added to the list of keys contained in the “in-memory” hash table, in step 750. In step 760, the spam filter reads the corresponding user demographic information for the current search query to determine whether the user entering the current search query has registered within the last 14 days. If the user entering the current search query has registered within the last 14 days, the current search query is disregarded and not forwarded any further, in step 740. If the user, entering the current search query, has registered more than 14 days ago, the current search query and the corresponding user demographic information and IP address are written to a file, in step 770. It is to be understood that the period of 14 days is exemplary of the presently described embodiment, and that in alternate embodiments the period may be shorter or longer than 14 days. In step 780, the current file is forwarded to the select search server 40.

For example, a user having demographics matching the desired demographics enters the search query “britney spears”. The search query “britney spears” passes successfully through the first content filter 30, the second content filter 60, and the demographic filter 70, which passes it to the spam filter 80, along with the user demographic information and IP address of the user's user station 10. The spam filter 80 combines the terms “britney spears” and the IP address and adds this combined key to the “in-memory” hash table. In this example, any subsequent search query “britney spears” received from the same IP address will be compared to the “in-memory” hash table, will be found, and will not be forwarded any further.

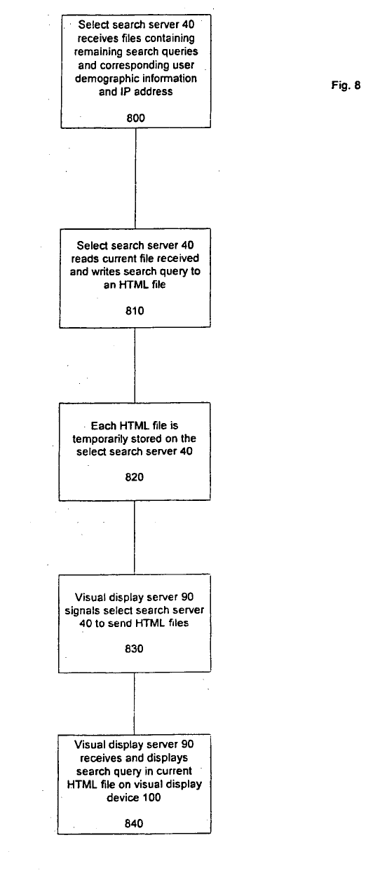

A process for selecting and displaying search queries on the visual display device according to one embodiment of the present invention will now be described with reference to FIG. 8. In step 800, the select search server 40 receives files, each containing a search query that has passed through the filters and the corresponding user demographic information, forwarded from the spam filter 80. In step 810, the select search server 40 reads the current file received from the spam filter 80 and writes the current search query to a file, such as an HTML file. In step 820, each HTML file is temporarily stored on the select search server 40. In step 830, the visual display server 90 signals the select search server 40 to send a certain number of files, for example, 100 HTML files, every minute (to ensure search queries being displayed are in or close to substantially real-time). In alternate embodiments, the number and type of files and amount of time between the sending of files may vary, since it is preferred that search query terms are updated for display often enough to provide a smooth scroll on the displayed “ticker” portion of the perceptible output to show the progress of differing queries over time. The scroll speed may be adjustable to suit the specific medium or environment of presentation. In step 840, the visual display server 90 receives and displays the search query contained in the current HTML file on the visual display device 100, such as a video screen or stationary or mobile video billboard.

Persons of skill in the art will recognize that, although the above-referenced system components are discussed and shown as singular units, as a matter of design choice, any number of system components, in varying hardware, software or firmware combinations may be utilized within the scope of the present invention. For example, in alternate embodiments, the system may include multiple monitoring web servers communicatively coupled to one or more select search servers, which are, in turn, communicatively coupled to one or more visual display servers. Servers may be software or hardware and software or firmware implementation. Additionally, in alternate embodiments, any one or more of the aforementioned filters may be used, in any order, to determine which search queries should be displayed. It is to be understood that any of the aforementioned filters may run, separately or in combination, on any one of the aforementioned servers or any additional components, or may be implemented in fewer or greater number of hardware or software components. Moreover, the specific filtering criteria, including demographic criteria, and output format may be flexibly applied as a matter of design choice to provide many different ad campaigns, brand affinity campaigns, website affinity campaigns, news related informational ads, and the like, incorporating search terms or other user input obtained in any number of ways, as a matter of design choice.

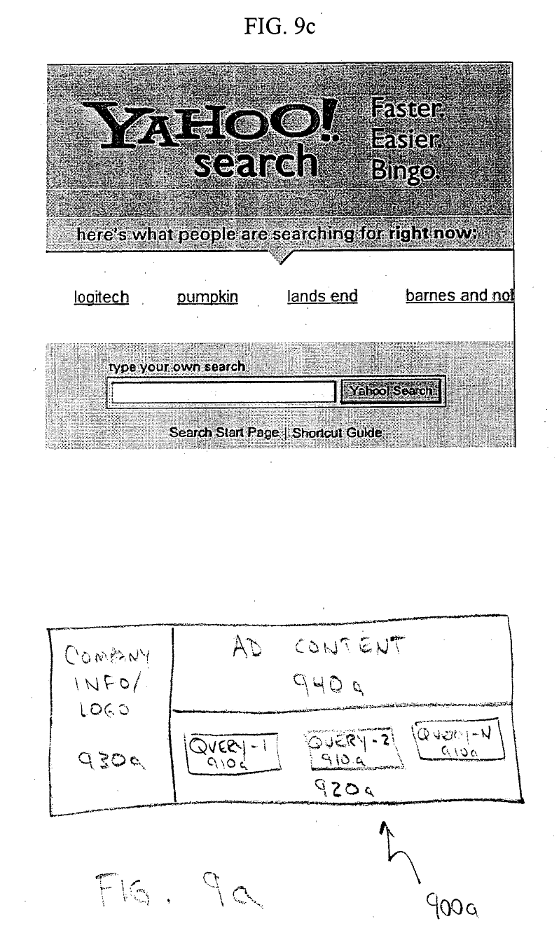

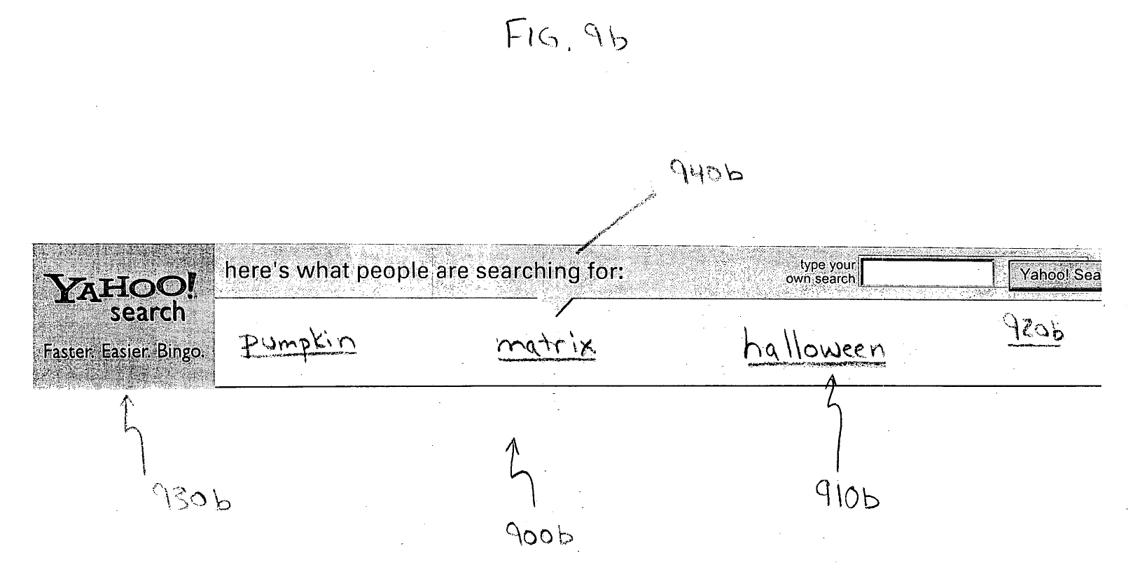

The system of the present embodiment is also capable of writing or sending different forms of output to be accessed by the display server 90 based on command-line input parameters. The search queries may also be presented in other perceptible ways, such as audibly, using text to speech conversion, either at the server or at the viewer's output device, or by other known means. In one embodiment, in addition to the first and second content filters, further filters are utilized prior to the select search server 40 writing output to be accessed by the visual display server 90. Such output may take different forms, for example, an XML data feed containing the search queries and/or associated demographic information. In another embodiment, where the output is a substantially real-time stream of user inputs, the second content filter 60 directly writes resulting lines out to a javascript-enabled HTML or XML file, for example, periodically, every 30 seconds. The javascript in the file allows a browser to scroll through a list of search queries set by second content filter 60, and to reload the file on a configurable time interval to refresh the displayed scrolling terms. This allows users to see the latest search queries updated and displayed in substantially real-time. For example, in FIG. 5, following step 560, the remaining search queries and demographic information may be pulled in XML files from the select search server 40 or additional server following the second content filtering to be displayed in an advertisement on a web page, as described herein in FIGS. 9-14.

In an exemplary embodiment, as shown in FIGS. 9-14, the search queries remaining after some or all of the previously described filtering is shown as used on a web page, for example, in an advertisement, presented to users via the Internet or other network. FIG. 9a generically illustrates a layout of the exemplary ad 900a of the present embodiment to include a scrolling search query window or “ticker” 920a having the queries 910a, (preferably appearing as horizontal scrolling text although the queries may scroll vertically or flash on and off) the advertiser's logo and/or name in another window 930a and the advertiser's message 940a. A more specific example of this form of advertisement is illustrated in FIG. 9b, which illustrates the advertiser's, Yahoo!'s logo in one window 930b, Yahoo!'s advertising message in another window 940b, and the search queries 910b scrolling horizontally in the ticker 920b. Of course the configuration, orientation and visual characteristics of the ad or web page or screen display portion may be flexibly configured any number of ways as a matter of design choice.

In the present embodiment, the advertisement 900a is a banner ad and includes scrolling search queries 910a that are received and displayed in near real-time and that meet certain defined, targeted demographics, although non-real time and generic, non-targeted search queries may be used in alternate embodiments. In the present embodiment, advertisement 900a is served on a website to viewers that typically meet certain demographics and includes filtered search queries 910a that have been entered by users having the same demographics, thereby providing viewers of the advertisement 900a with search queries 910a potentially most relevant to the viewers.

It is to be understood that the advertisement 900a may take any form, such as a banner ad, skyscraper ad, pop-up ad, pop-under ad, and the like, with any number and form of visual and other elements. Thus, for example, a visual display may be offered to user in such a manner as to provide a stimulating and highly relevant user experience. The systems and methods herein described may be used to advantage by internet content providers to induce advertisers to serve ads on the provider's site, by ad agencies seeking to present highly relevant and entertaining ads with high user retention potential, by search engines seeking to highlight their services, or by companies offering products and/or services targeted to particular user populations or demographics. For example, a search engine provider could offer the inventions herein described to an ad agency that in turn would offer to design an ad campaign for a company selling a product. If the product was a basketball sneaker, for example, the ad or webpage or visual display could contain information about the sneaker while also displaying scrolling search terms entered by young males, aged 16-20, from five selected cites. As another example, the inventions herein could be applied to any searches, for example, searches for TV programming, and displayed as part of our on-screen program guide. Thus, a TV network or cable or satellite provider or television guide channel could enable a TV watcher to see what other TV watchers were searching for in a program guide. Other users and applications will be apparent from the teachings herein.

Another exemplary embodiment includes using the advertisement to display search queries entered on a particular partner website ad that display that partner's logo and advertising message. For example, ABC Company may include a Yahoo! Search query tool bar on its website. Visitors to the ABC website may thus enter search queries on the website. These same queries may be used, either directly or after being filtered by any one or more of the filters described herein, in an advertisement displaying the ABC Company logo, advertising message and/or any other material. Thus, for example, the partner could display a message “Look what others are searching for at ABC Website,” and actually display such search queries.

In another embodiment, the advertiser specifies filtering criteria that are associated with the product (i.e., good or service) being advertised. Such association may take on any degree of relevance between the filtered search queries and product. For example, such association includes that of genus and species, (e.g., a query of “appliances” and a product being a specific brand and type, such as dishwasher), species and species (e.g., a query for a certain appliance, such as stoves, and a product being another appliance, such as dishwashers) or simply where the product is a possible search result to the query.

Such a targeted advertisement 900a may be implemented, for example, with the system of FIG. 1, an advertising server (which may be an existing server or a separate server or other computing device or software) for serving the ads, and additional advertisement functionality coded in Macromedia FLASH using files with a “.swf” extension (referred to herein as “SWF” files) and a movie clip, although no specific multi-media, graphical or audio/visual is required, but instead may be varied to use various presentation techniques now known or later to become known. An exemplary FLASH-based implementation uses three SWF files—a Shim SWF, a Scroll SWF, and an Ad SWF. The present exemplary embodiment uses these files to extract the search queries 910a and demographic information associated with such queries 910a from an XML document provided by the select search server 40 of FIG. 1. Such XML document is referred to as a feed.

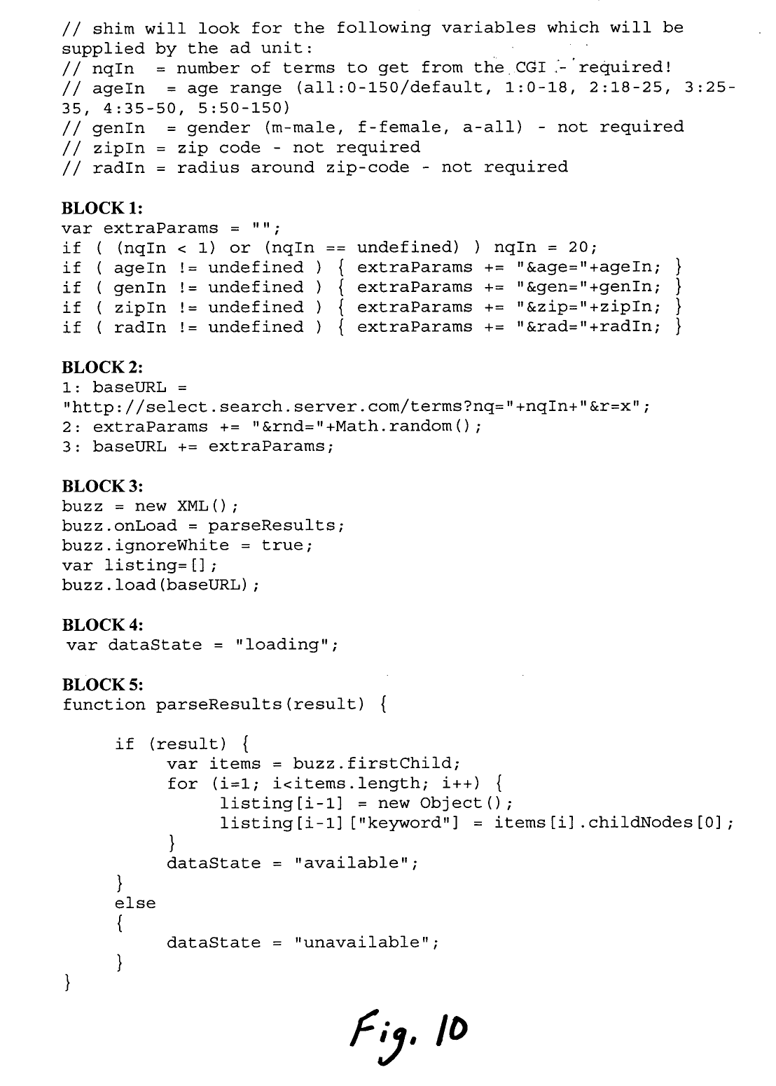

The first SWF file is a Shim SWF. Due to the security model for Flash, version 6, text data cannot be loaded past a subdomain. By way of example, this means that a file on www.yahoo.com would be able to load a file on search.yahoo.com, but would not be able to load a file from the domain other.search.yahoo.com or www.hotjobs.com. An exception to this model is that SWF files can be loaded from any domain. Thus, because the present embodiment includes the text to be loaded, namely the search queries (from the XML feed) and the relevant URLs (e.g., URLs pointing to one or more searchURLs), the Shim SWF is used. More specifically, the Shim SWF is a SWF file that sits on the same server as the text file to be loaded, in the present embodiment, the select search server 40. The Shim SWF has no visual elements. It is one blank keyframe with the exemplary code of FIG. 10 in it. For ease of discussion, the code has been illustrated as segmented into logical units referred to as blocks). Notably, where such a security model is not present (e.g., if Flash, version 7, or some other programming language issued), the Shim SWF is not necessary.

According to the code in Block 1, the Scroll SWF may be loaded with various parameters, which the Scroll SWF uses to set parameters on the Shim SWF, such as any one or more desired demographic criteria and any other parameters defining the ad 900a (in the present embodiment, the number of search queries 910a (nq), zip-code (zip), age range (age), gender (gen) and radius around the location of the zip code (rad)), to specify what search queries 910a are to be retrieved. These parameters are passed to the URL of the server (e.g., select search server 40) from which the feed is retrieved, then the parameters may be predefined, in which case, where the parameters are empty or undefined, the server specified in the URL simply ignores undefined variables. Certain variables, for example, the variable specifying the number of search queries 910a, can be set to default values, for example, twenty, in the case of the number of queries 910a, if no value is set. Where the URL is to be targeted to a certain audience (namely, where the pulled search queries are to meet certain parameters (i.e., criteria), such parameters can be passed to the Ad SWF file from the html code on which the ad 900a is displayed in any number of ways, including, for example, by appending the parameter names and values in a URL encoded format at the end of the Ad SWF filename, by using flashbars in conjunction with embed and object tags, javascript code, and the like. Once the parameters are passed to the select search server 40, or other server performing the filtering, the select search server 40 uses the parameters as the demographic criteria in the demographic filter 70. In alternate embodiments, the Ad SWF receives the feed and performs the filtering by selecting search queries having associated demographics meeting the demographic criteria specified in the Ad SWF

According to the code in Block 2, the basic feed URL is defined, specifying the number of search queries 910a to return and the requested XML format of the feed. The variable extraParams contains any values defining extra parameters, such as gender, age range, zip code, radius around zip code location and the like, that are used to specify the queries to be retrieved. Adding “&rnd=+Math.random( )” appends a variable and a random number value to the feed URL, which is ignored by the receiving server and makes it more likely that each call for the feed will come from the search server 40 and not from the user's cache, so that reloading the page will repopulate the Scroll SWF with new data.

According to the code in Block 3, an XML object is initialized, specifying what function “parseResults( )” (defined later in the code) to use on the data it acquires from the feed, and then defining which URL to load the data from (in this embodiment baseURL, which is defined earlier in the code).

According to the code in Block 4, an indicator variable, called “dataState,” is set to the value “loading” so that the Scroll SWF can check on the progress of the feed. This is accomplished by the Ad SWF checking the value of the indicator variable in a penultimate frame, using a logical check to decide whether to proceed to the final frame or to loop back to an earlier frame and perform a logical check again. When feed data is acquired, dataState will be changed to one of two values depending on the feed's success or failure: “available” or “unavailable”, respectively.

According to the code in Block 5, the function parseResults( ) is called when the XML data object determines that it has loaded the data or it cannot load the data. If the parameter result has usable data, a data object called “items” is created and the XML data is parsed and assembled into the items object. The items object is now available to the Scroll SWF loading the Shim SWF, so the variable dataState is set to “available” and this SWF Scroll ends. If the XML object determines no data can be retrieved, it sets the variable dataState to “unavailable” from which the Scroll SWF determines it will not be given live data from the feed. The Scroll SWF passes this information to the Ad SWF via its own variable, scrollStatus (see below), while the Shim SWF ends.

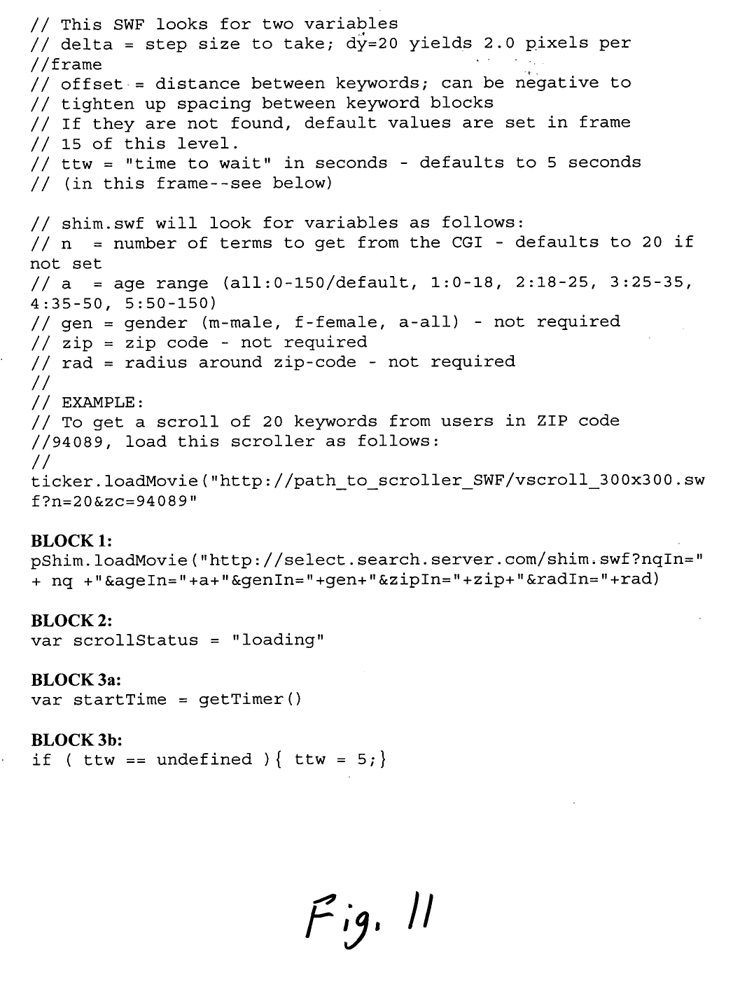

The second SWF file is a Scroll SWF. The Scroll SWF resides on the advertisement server. As described in greater detail below in connection with exemplary Scroll SWF code of FIG. 11, the Scroll SWF calls the Shim SWF to load text and contains code for creating the search query ticker 920a (scrolling list of the search queries 910a), including code that pulls search queries 910a remaining after the filtering process to populate the search ticker 920a. The Scroll SWF contains a timeline of blank keyframes with code attached to each, which will be described in greater detail below with reference to FIGS. 11-14. The Scroll SWF also contains a template defining what the text field for the search query 910a should look like and code defining what should happen when the user rolls over the search query 910a with the mouse or clicks on the search query 910a. For example, the code in the Scroll SWF may change a search query 910a from blue to red when the user passes over that search query 910a with the mouse, along with temporarily halting the scrolling of all of the search queries 910a in the search ticker 920a, while the mouse remains on any particular search query 910a. Additionally, the code in the Scroll SWF may determine whether the search queries 910a are displayed as scrolling horizontally or vertically. Each block of code begins with an indicator as to where the code is placed.

The Scroll SWF also includes the Scroll Movie Clip, which is implemented as a FLASH movie. The Scroll Movie Clip is a template movie clip in the Scroll SWF that receives the search queries 910a from the Scroll SWF and defines each pulled search query 910a as a separate data object, referred to as a search query data object. Each search query data object also may have certain properties associated therewith, as specified in the Scroll Movie Clip.

The Scroll Movie Clip is loaded into a third SWF file, referred to as an Ad SWF, which is implemented as a FLASH movie. The Ad SWF resides on the advertisement server and is displayed within a web page. The Ad SWF passes to the other movies the variables or parameters necessary to retrieve the correct information for the search ticker 920a and to have the search ticker 920a formatted properly. While the Ad SWF receives the parameters from the html code in the present embodiment, such parameters are hard coded in the Ad SWF in alternate embodiments. For example, the Ad SWF may determine which search queries 910a from the select search server 40 meet the described demographics and should be displayed in the search ticker 920a. Additionally, the Ad SWF may cause a banner, title or other ad content, such as “Here's what people are searching for:” to be written in the text window 940a and have the scrolling search queries 910a defined in the Scroll Movie Clip described below, as in FIG. 9a. The Ad SWF may also define a search tool bar for allowing a user to enter new search queries 910a.

When a user selects, or clicks on a search query 910a as it scrolls across the ad 900a, javascript written to the Ad SWF appends the selected search query 910a to a search URL defined in the javascript and issues a search request to the search server specified in the URL to perform a search on the search query 910a. In an alternate embodiment, Action script, rather than javascript, is used. More specifically, the Action script makes a “geturl” command, which causes the user's browser to go to the search URL.

As noted above, in the present embodiment, the Scroll Movie Clip additionally filters the remaining search queries 910a retrieved from the select search server 40 to determine which search queries 910a should be received by the Scroll Movie Clip and displayed via the Ad SWF. Such additional filtering may be accomplished in any number of ways, including the ad comprising the demographics in the feed for each query 910a to the parameters of the ad or by passing the parameters to the demographic filter described above. It is also to be understood that the search queries retrieved from the select search server 40 may be unfiltered or may be filtered by any one or more of aforementioned filters. In certain alternate embodiments, the Scroll SWF may pull a group (e.g., ten) of remaining search queries 910a and those search queries 910a will be included in the Scroll Movie Clip to be repeatedly displayed for a period of time (e.g., five minutes), and then a new group of ten remaining search queries 910a will be pulled by the Scroll SWF. It should understood by those skilled in the art that the number of search queries 910a pulled in each group may be greater than or less than ten and the period of time for display of such search queries 910a may be greater than or less than five minutes. In alternate embodiments, the Scroll SWF will pull remaining search queries 910a, one at a time, and the current search query 910a will be displayed in the form of a search query data object immediately following the preceding search query data object within the Scroll Movie Clip.

Exemplary code of the Scroll SWF now will be described in connection with FIGS. 11-14. Although the code is described as associated with particular frames, such frames are exemplary and the code may be implemented in fewer, greater and/or different frames.

In FIG. 11, the code for frame 1 of the root timeline is described. According to the code in Block 1, the Scroll SWF attempts to load the Shim SWF from the select search server 40. The Scroll SWF will, upon loading the Shim SWF, attempt to load the queries 910a from the feed into a data object available to the Scroll SWF. Parameters to modify the feed, such as, the spacing between search queries and demographic criteria identifying which search queries to receive, can be passed during this step. By changing the parameters passed into the Scroll SWF, search queries 910a meeting such charged parameters can be displayed.

According to the code in Block 2, an indicator variable is set so that the Ad SWF loading the Scroll SWF can check the status of its progress.

According to the code in Block 3a, the variable “startTime” is set, which stores the time the movie has existed. As such, the variable provides the baseline by which the passage of time is measured.

According to the code in Block 3b, variable “ttw” (time to wait) is set, which indicates to the Scroll SWF how many seconds to wait before giving up on obtaining the feed. In the present embodiment, the default time to wait is set at 5 seconds, if no time to wait value is specified.

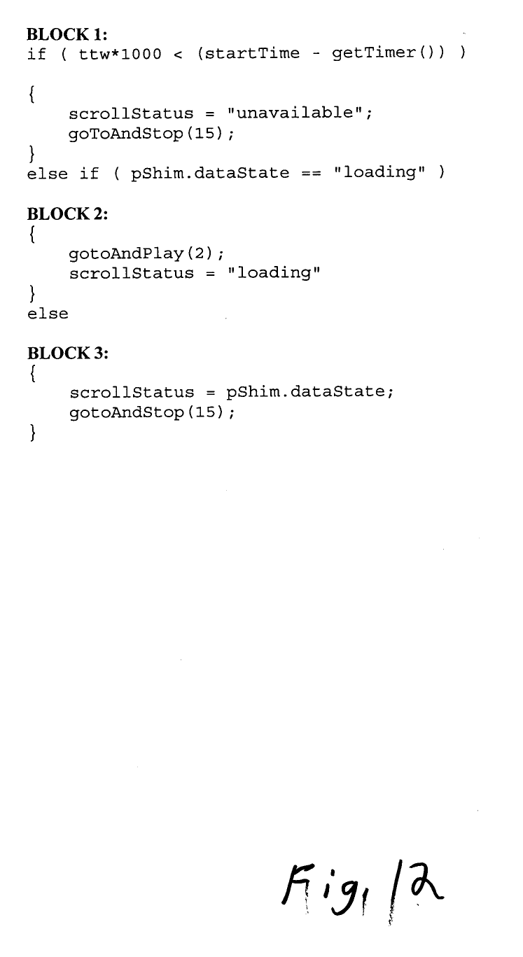

The code for frame 14 of the Scroll SWF will now be described with reference to FIG. 12. During the loading of the data feed, the Scroll SWF code checks the Shim SWF's progress in downloading the feed data, namely, the search queries and associated meta data identifying the query (e.g., demographics).

According to the code in Block 1, if the Scroll SWF has been trying to load the data from the Shim SWF for longer than the time to wait that has been set, the indicator variable “scrollStatus” will be set to “unavailable”, and the Scroll SWF will stop trying to load the data from the Shim SWF and goes to frame 15. The Ad SWF loading the Scroll SWF will then know data is not forthcoming, and can then take alternate action, such as displaying static data, displaying a more generic ad, and the like.

According to the code in Block 2, if the Scroll SWF is still loading the data from the Shim SWF, as indicated by the Shim SWF's variable dataState, the scrollStatus is explicitly set to “loading” (though this should not be a change from the assignment in Frame 1, above), and then return to frame 2.

According to the code in Block 3, if dataState does not equal “loading” (and therefore, will have one of two values, “available” or “unavailable”), the value of dataState should be assigned to scrollStatus and then go to the next frame.

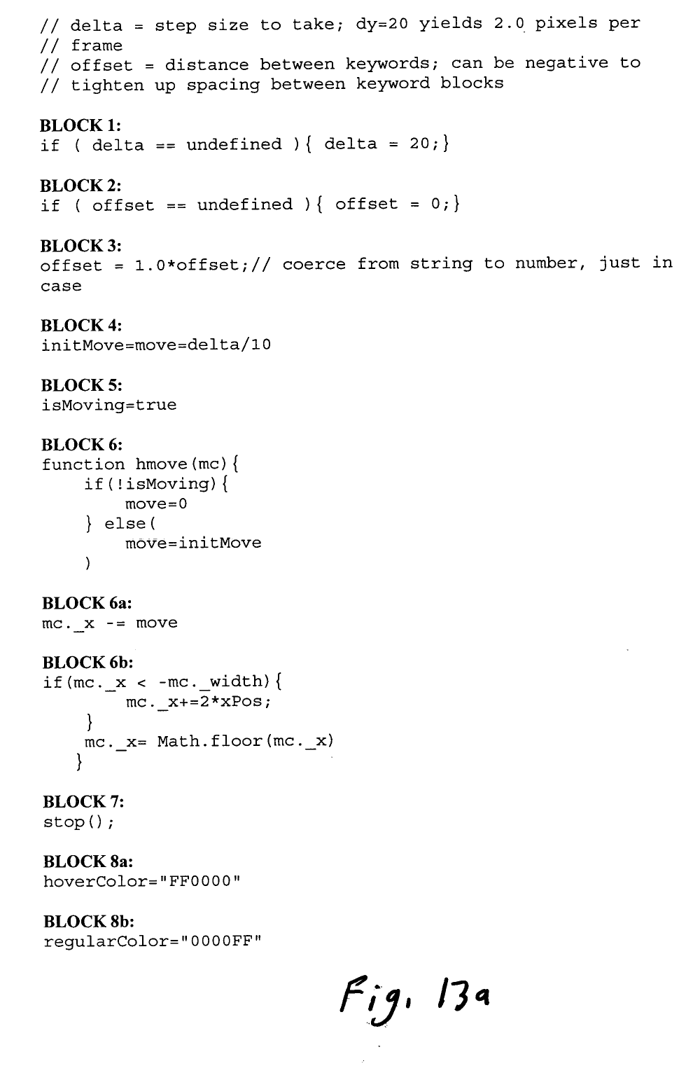

The code for frame 15 of the Scroll SWF will now be described in connection with FIGS. 13a and 13b.

According to the code in Block 1, the variable “delta” defines the amount in pixels to move the Scroll Movie Clip each frame. If no delta value was passed from the URL that loads the Scroll SWF into the Ad SWF, delta is set to a default value of twenty, which translates to two pixels per frame, although other defaults are possible.

According to the code in Block 2, the variable “offset” defines the distance between consecutive search queries 910a in the Scroll SWF. If no offset value was passed from the URL that loads this Scroll SWF into an Ad SWF, the code sets a default value of zero pixels although other defaults are possible. (The value of zero puts consecutive search queries 910a right next to each other).

According to the code in Block 3, the variable offset is a string by default when passed from the Scroll SWF's URL, so offset must be set to a numerical value. Its intended value remains the same.

According to the code in Block 4, the variables “initMove” and “move” are set to the value of delta divided by ten (delta/10). The value of initMove will not change as the Scroll SWF runs, but the value of move will alternate between 0 and initMove's value, depending on whether the Scroll SWF should move or not (i.e., the Scroll SWF stops when the user mouses over a search query 910a in the Scroll SWF). By scaling delta by a factor of ten, the string value of delta can be set to a numerical value where delta is passed from the Scroll SWF's URL.

According to the code in Block 5, the variable “isMoving” is a flag for allowing the Scroll SWF to advance by zero pixels, or by the amount defined by delta and initMove. Each search query 910a in the Scroll SWF can switch this from true to false if it detects a mouse over itself.

According to the code in Block 6, this function block is called by each search query 910a in the Scroll SWF every time the Scroll SWF is animated. If the Scroll SWF should not be moving, the variable move is set to zero. If the Scroll SWF should be moving, the variable move is set to the default value received from delta.

According to the code in Block 6a, each object in the Scroll SWF moves to the left by the amount in variable move (i.e., either zero or the amount received from delta).

According to the code in Block 6b, the ticker 920a is presented to appear as a closed loop of search queries 910a. In the present embodiment, the code creates two copies of the received search queries, presenting them one after another. If the Scroll Movie Clip has gone so far to the left that its second copy is now visible, the first copy is moved to a point beyond the end of the second copy (i.e., so the first copy follows the second copy, thereby maintaining the illusion of an unbroken loop.

According to the code in Block 7, calling the function “stop( )” causes the Scroll SWF to stop animating, although the search queries 910a within the Scroll SWF will continue to move. The Scroll SWF will not loop back to frame 1 and attempt to reload the Shim SWF.

According to the code in Blocks 8a and 8b, the color values, “hoverColor” and “regularColor”, for the scrolling search queries 910a are set to red for when the scroll is not moving due to a mouse-over and blue for when the scroll is moving, respectively.

According to the code in Block 9, the URL builds links to the search site and performs a search on demand for the user. Opening a link to “searchURL” plus a keyword will point to a search results page in the browser for the search query 910a corresponding to the keyword. In alternate embodiments, the Shim SWF loads a separate search URL for each received search query, where each such URL includes the associated search query 910a already appended thereto.

According to the code in Block 10, if there is data to be loaded from the Shim SWF, an empty array is created, the array's value is set to the data object listing in the Shim SWF, and the function “formatResults( )” is called to build the Scroll SWF. If there is no feed data to be loaded, the Ad SWF provides an alternative display, such as static content, an alternate ad, a default (static) group of search queries and the like, and not the scrolling ticker 920a. Such alternate display can be provided in any number of ways, including, for example, running a block of code that, upon determining the data feed to be “unavailable”, specifies that the code use specified data, runs a specified movie, jumps to a certain “default” frame in the movie, and the like. Alternatively, the code could define “buzz” (referenced in the Shim SWF) as being the default display, such as the default queries, and then have the function parseResults( ) call buzz.

According to the code in Block 11, the code builds a separate Scroll Movie Clip for each object in the array passed as data from the Shim SWF to the Scroll SWF. Two copies are made for each object in the array, defined as “mc1” and “mc2” (Scroll Movie Clips 1 and 2). They are for the first and second copy of the Scroll Movie Clips (buzzMC1 and buzzMC2, respectively). The Scroll Movie Clips' properties are set in parallel, as they are essentially, including identical to their relative position within their respective buzzMC1 or buzzMC2. The search queries 910a in the Scroll Movie Clips have parameters txt, keyword, head, and URL (although the URL is not actually used in the present embodiment). The parameter “keyword” is the actual text of a search query 910a, as received from the feed and is interchangeable with the property txt. The parameter “head” is the text as displayed by each object in the Scroll SWF, with color and style as defined by HTML tags.

In alternate embodiments, the URL parameter of the Scroll Movie Clip can be used in replace of the function call that causes the URL, including keyword, to be built and passed to the search URL. More specifically, in such alternate embodiments, the user clicks on the (query) link and the code opens the stated URL, such as that of a search page.

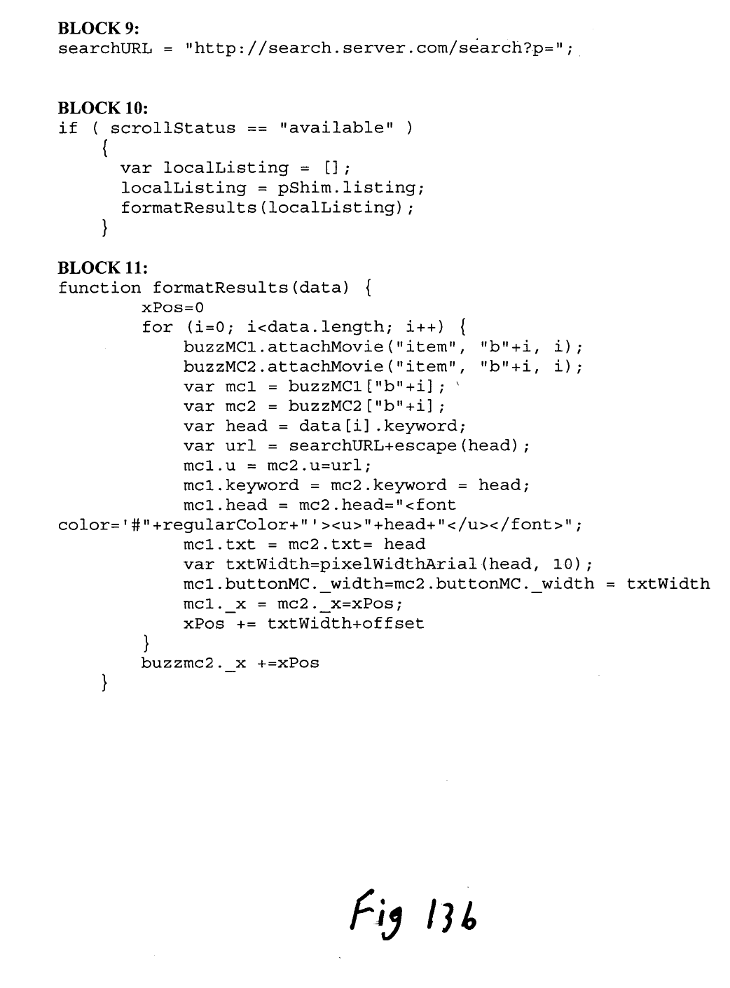

The code for the button inside the search query template will now be described with reference to FIG. 14, which shows the code that each search query 910a in the Scroll Movie Clip uses to control display and movement of the search ticker 920a.

According to the code in Block 1, when a search query 910a detects a mouseover (when the user moves their mouse over the search query 910a), it stops the search ticker 920a (setting the Scroll SWF's variable isMoving to false) and changes the search query's color from blue to red.

According to the code in Block 2, when the mouse is no longer over the search query 910a, the search query 910a signals the search ticker 920a to resume, and reverts the search query's appearance to the default state, namely, blue and underlined text.

According to the code in Block 3, if a user clicks a particular search query 910a, it calls a function “doClick( )”, which is implemented by the Ad SWF which loads the Scroll SWF into the advertisement 900a. The function causes the search query 910a to be passed to the Ad SWF, which can do whatever it wants with the data, including passing it to a search URL, via the FSCommand/JavaScript approach described earlier. A search is performed and the results are displayed in a new browser window, although in alternate embodiments the results are displayed in the same window. In still other embodiments, rather than performing the search, stored results corresponding to a previously performed search for the selected query 910a can be retrieved. In other alternate embodiments, the Scroll SWF is loaded along with the page, instead of within the advertisement. In other embodiments, activiating the link causes the search to be performed and the results to be displayed in the ad 900a, itself, or on the same page on which the ad 900a is displayed.

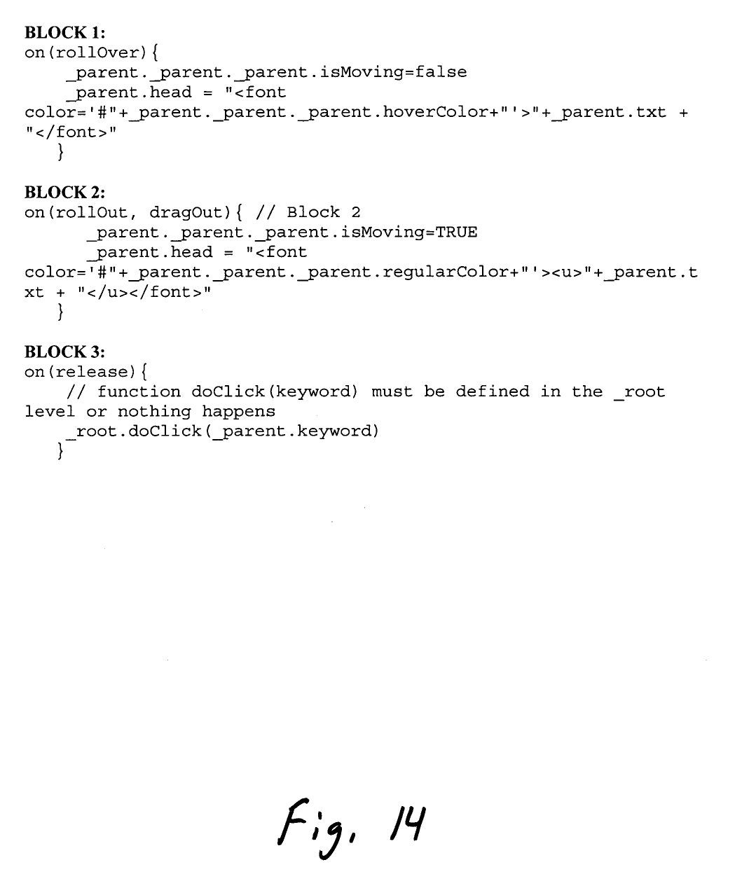

As noted above, the filtered search queries may be displayed by any number of display devices. These may be physically or electronically segmented portions of single display, or three separate displays, or combinations thereof, in any size, from a cell phone or PDA display to an outside billboard on a building. Exemplary embodiments of the visual display device 100 will now be described in greater detail with reference to FIGS. 15-17. In an exemplary embodiment, as shown in FIG. 15, the visual display device 100 has three video screens: a top video screen 110, a center video screen 120, and a bottom video screen 130. The top video screen 110 contains the brand name of a product or service to be displayed, such as, for example, “Yahoo!”. The center video screen 120 contains a message and/or graphics representative of a particular product or service that is being promoted. The bottom video screen 130 contains an alternate visual of the brand or service to be promoted and/or a search query display portion in which search queries entered by users and remaining after the filtering process are displayed.

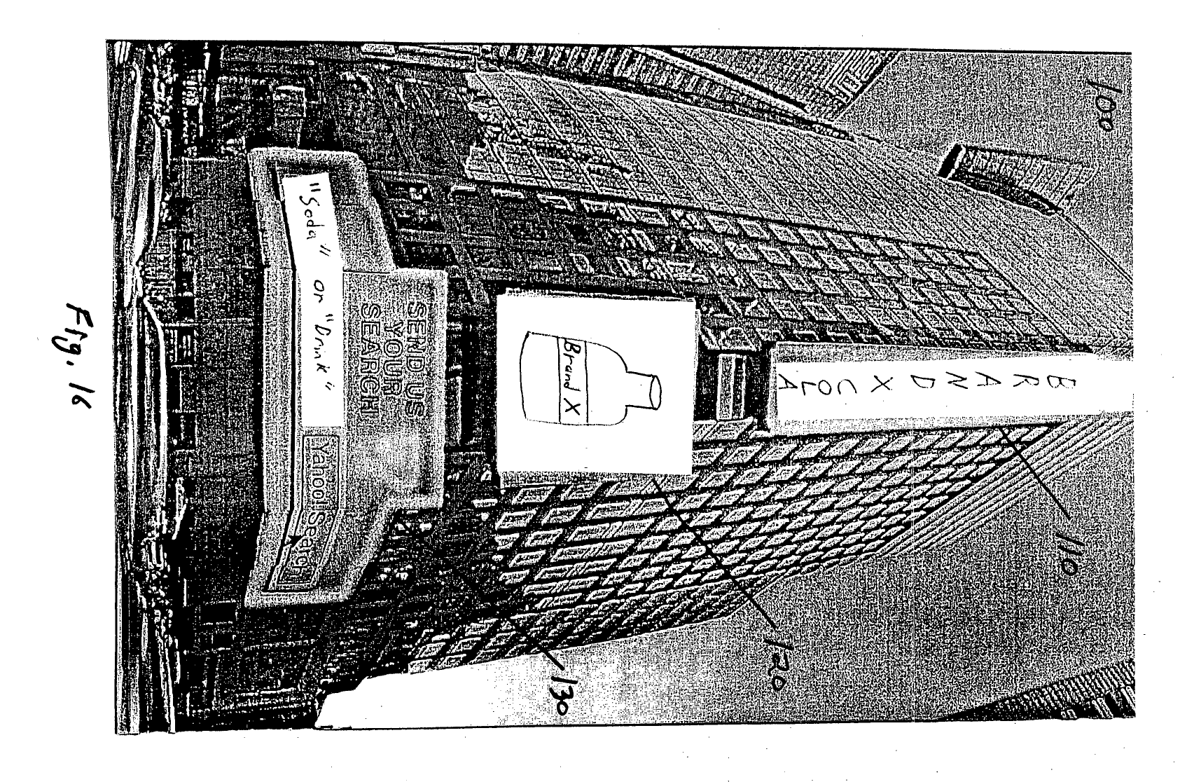

More specifically, the center video screen 120 contains a message and/or changing visual graphics, for example, representative, indicative, suggestive or exemplary of a particular product or service (referred to as “product” for convenience) that the system provider is endeavoring to promote through the use of the present embodiment. As depicted in FIGS. 15-17, the center video screen 120 may alternately change from a message depicting the identifying name of some brand or product that is being advertised to a visual, graphical or pictorial image, or combinations thereof, which depict scenes that reflect the particular brand or product. In the depicted embodiment, the center video screen 120 alternates from displaying the message: “the new YAHOO! Search” product, which is a service to be promoted, to pictures of persons pictured with a search toolbar containing a search query that is relevant to the image being depicted. Thus, for example, in FIG. 17, there is depicted a family in a snowy scene wearing heavy clothes holding a sign reflecting a Yahoo! search toolbar with a search query “Palm Springs Weather”. By displaying the search query, toolbar and other related images reflecting the product or brand being promoted and alternating that image with an image of the product actually being utilized by persons or related to use by persons, often in ironic or humorous ways, the visual impact and brand retention is highly increased.

In alternate embodiments, the resultant data in the center video screen 120, such as images, search results or data resulting from the processing of the search query or other input data entered by the user, could be reflective of the search queries actually being displayed in the bottom video screen 130, as described below. Thus, if a search query for Persian cats was entered by a user, and such query passed all filters and was being displayed in the search query display portion of the bottom video screen 130, pictures of or relevant to Persian cats would be displayed in the center video screen 120, or alternatively, search results for Persian cats would be displayed in the center video screen 120. Such pictures or search results may include those found on the Internet as a result of the search. Alternately, the tool bar depicted as part of the image portion of the outdoor ad (for example, as being held by the family in FIG. 17) could also display the actual search query being displayed as part of the search query display portion of the bottom video screen 130.

Alternatively, the system could be programmed to call up predetermined or “stock” images that relate in some way to the actual search query being displayed, such as for example, searches having to do with warm weather vacations, such as “hotels in Orlando” would result in the selection of a stock image of a family on a beach or near a pool. In such embodiments, one or more words and/or phrases are associated with one or more images. Such words or phrases are stored in a table or flagged as associated with the images. When such words or phrases are used in a query, as determined by a filter parsing the query, the associated image is accessed and displayed in the center video screen 120.

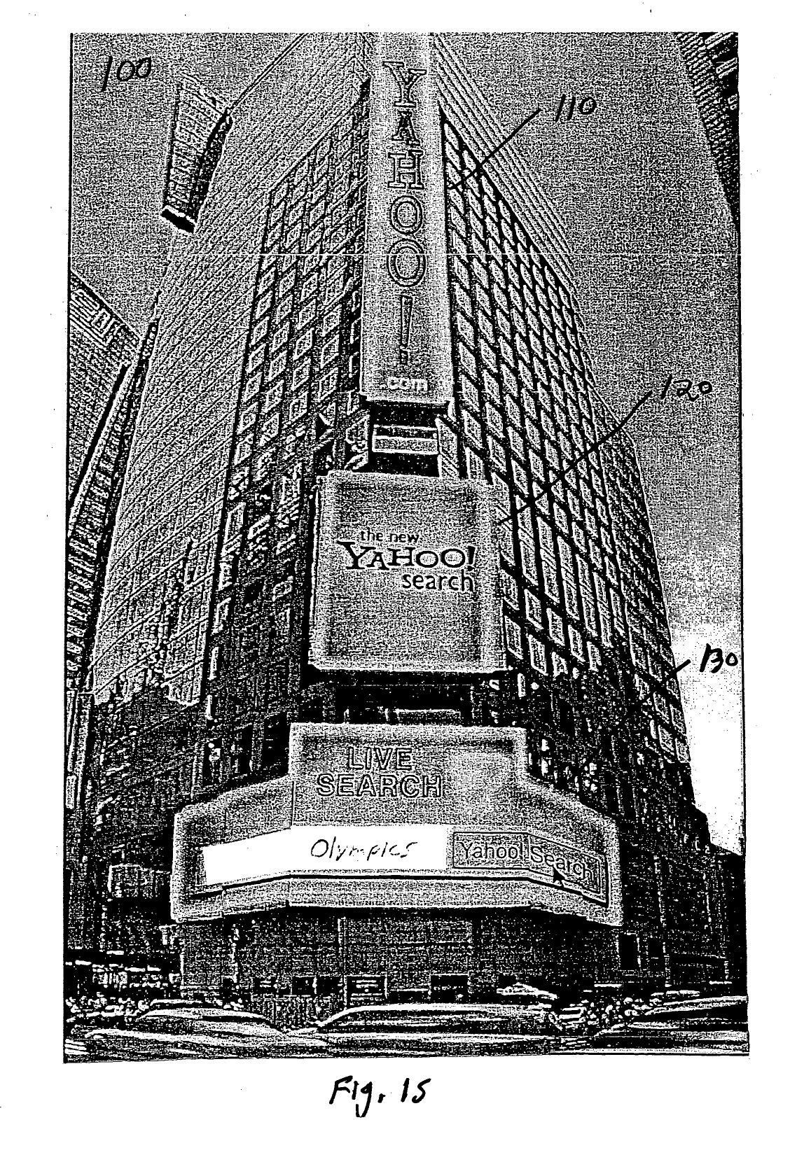

In certain embodiments, rather than displaying stock images, an advertiser's image is displayed. More specifically, an advertiser may pay to have its product associated with certain subject matter searches and/or search words and/or phrases. Each time an associated search is displayed, rather than displaying a stock image, the system displays the advertiser's brand name in the top video screen 110 and a picture of the advertiser's product in the center video screen 120. For example, as shown in FIG. 16, a soda company named “Brand X Cola” could pay the system provider to have its product associated with search queries including “soda”, “drink”, or “beverage”. Each time a search query including such words is displayed in the bottom video screen 130, the system would additionally display the brand name “BRAND X COLA” in the top video screen 110 and/or a picture of a Brand X Cola bottle in the center video screen 120.

The bottom video screen 130 of the visual display device 100 contains an alternate visual of the product to be promoted, and a search query display portion in which search queries entered by users and remaining after the filtering process are displayed, as depicted in FIGS. 15-17. In actual use, the search query display portion of the bottom video screen 130 would reflect changing search queries that are indicative of actual search queries entered by users that have made it through the filtering process and have been accessed by the visual display server 90 to be displayed on the visual display device 100.

For example, if the visual display device 100 were to be located in New York, the visual display server 90 could pull only searches being performed in New York, after filtering by the demographics filter 70, and display the search queries in the search query display portion of the bottom video screen 130, or, for an even more stunning visual impact, could reflect searches being performed in remote places such as, for example, Europe, the Far East, or particular countries or regions therein. Alternately, the filters could be implemented to allow the display of search queries reflecting certain particular world events, sports news, or any other service of the organization operating or purchasing the services of the organization operating the system and method of present invention to promote a service. Alternately, a user station 10 proximate to the visual display device 100 could be interacted with to encourage persons viewing the visual display device 100 to submit search queries to be displayed.

Allowing users of the system or method of the present embodiment to enter search queries for the purpose of having those search queries or resultant data, such as images or search results associated with such search queries, projected onto a visual display device 100 will increase the level of interaction between users of the system and providers of the products and services utilizing the inventions disclosed herein and improve promotion of the products and services offered by such provider to users of the system and viewers of the visual display device 100. This will create a stronger and more intimate connection between the providers utilizing the disclosed embodiments and those persons that the providers are seeking to reach through the use of the inventive systems and methods disclosed herein.

In certain embodiments, the search query and user demographic information monitored and filtered is additionally processed to determine and display resultant data that could be used to promote products and services. This resultant data may include the following: images associated with certain words and/or phrases, search results for corresponding search queries, top ten lists compiled from search queries or user demographic information from users entering search queries, trivia games and contests, and the like. For example, an additional processor or filter may read the user demographic information corresponding to search queries entered by registered logged-in users for a specific period of time and determine from which cities the most search queries have been entered, and then forward these cities to the visual display server 90 to be displayed on the visual display device 100 in the form of a top ten list. Additionally, an additional processor or filter may read the search queries entered by users to determine the most frequently entered search queries for a specific period of time and then forward these terms to the visual display server 90 to be displayed on the visual display device 100 in the form of a top ten list. This additional processing step may be implemented prior to or following any of the one or more aforementioned monitoring or filtering steps.

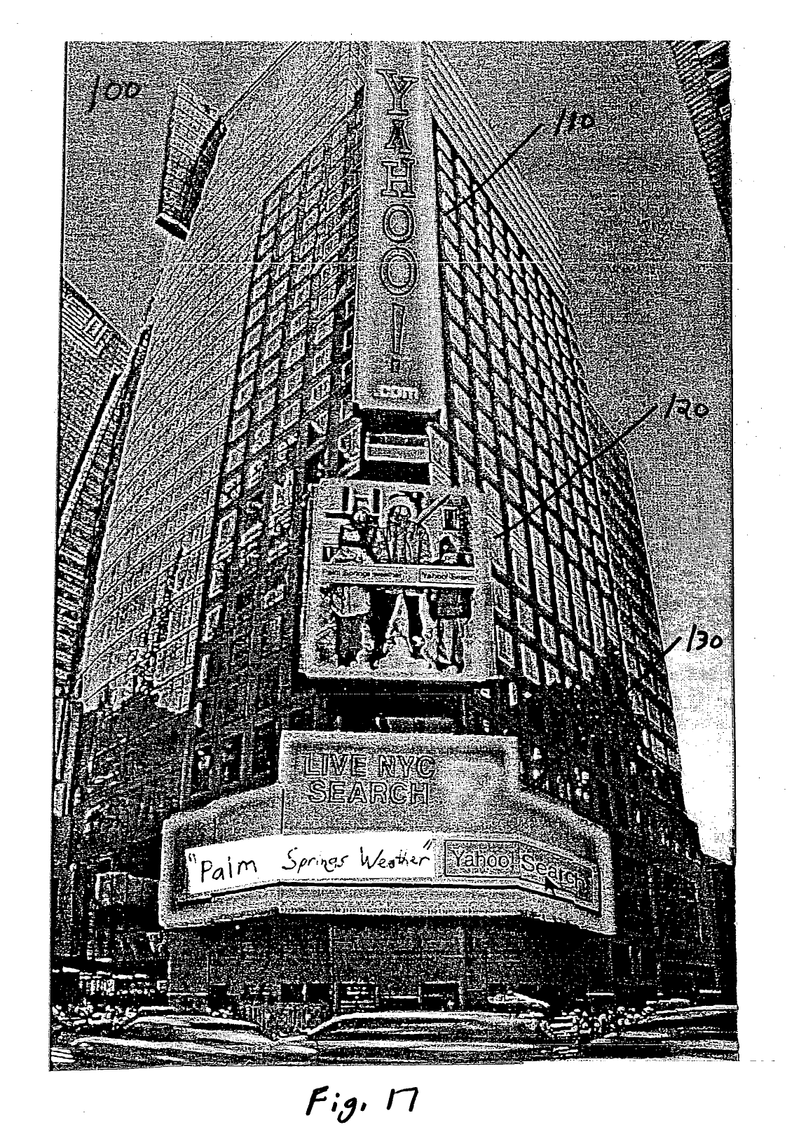

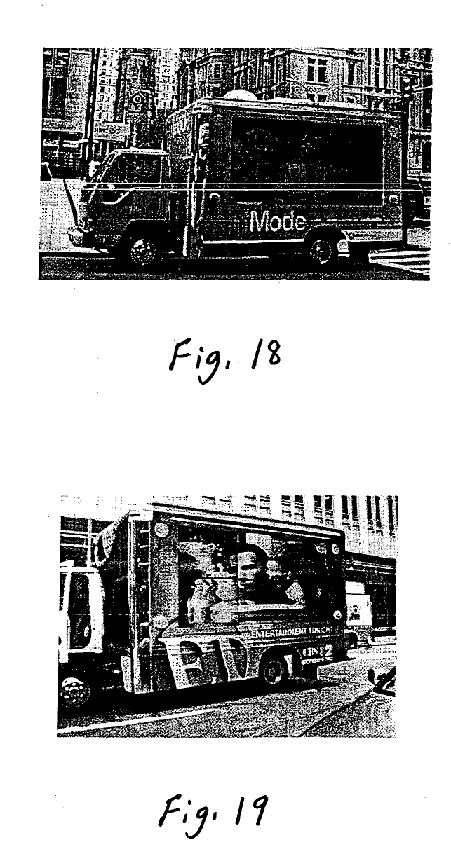

In further exemplary embodiments, as shown in FIGS. 18 and 19, the visual display device 100 may comprise a video screen, monitor, television, billboard or the like, mounted onto a wirelessly communicative mobile unit, such as a truck or van to allow the public display of any of the aforementioned information at a variety of events, such as festivals, sporting events, conventions, holiday events, and the like, such as, for example, football related queries displayed at or in connection with the Super Bowl. The system provider, by accessing and revising the hash tables for each filter, could choose to display certain information that the system provider determines would be of high interest to the crowd of viewers present at a specific event and would best promote certain products and services to such viewers. In one embodiment, a truck having a large viewing screen is driven from popular event to popular event featuring a list of top ten search queries or search result lists (e.g., these search queries most frequently entered by users) that correspond to the event at which the truck is located or a particular website or particular demographics or other filtering criteria. In one such embodiment, the system increments a counter each time a search query is entered over a certain time period, noting the most popular. Where a service provider has multiple displays (whether mobile, stationary, or both), each display may have one or more unique filters associated therewith, for example, a filter to identify queries entered by users from the same geographic location as the display and/or a filter to identify queries entered by users in the same age category as the likely audience of an event where the display is located.

Further, it should be understood by those skilled in the art that the present invention is not limited to the monitoring, filtering, and display of only search queries. In alternate embodiments of the present invention, the input data entered by the user at the user station 10 other than search engine queries can be monitored, filtered, and/or displayed to one or more persons directly or after additional processing, by any of the aforementioned systems and methods. For example, information entered to an auction web site, a department store web site, a video game web site, and the like, could be used to promote specific products and services to one or more members of the public.

Furthermore, it should be understood that the present invention may be implemented on a network other than the Internet or World Wide Web, such as a corporate intranet, or other communication network now known or hereafter to become known. For example, a corporate information services department may filter users' queries into an on-line “help” application, thereby tracking users' queries, and display answers or tips in response to the most frequently asked queries.

Those skilled in the art will recognize that the method and system of the present invention has many applications, may be implemented in many manners and, as such, is not to be limited by the foregoing exemplary embodiments and examples. Additionally, the functionality of the components of the foregoing embodiments may be implemented in different manners. Further, it is to be understood that the steps in the foregoing embodiments may be performed in any suitable order, combined into fewer steps or divided into more steps. Thus, the scope of the present invention covers conventionally known and future developed variations and modifications to the system components described herein, as would be understood by those skilled in the art.

What is claimed is:

1. A method of providing a display, the method comprising:
receiving search queries from multiple users;
filtering the search queries based on one or more filtering criteria; and
initiating display of filtered search queries to viewers, the viewers remote from the users.

2. The method of claim 1, wherein the filtering criteria include words.

3. The method of claim 1, wherein the search queries have associated demographic information and the filtering criteria include demographic criteria, the filtering including identifying queries having demographic information matching the demographic criteria.

4. The method of claim 3, wherein the viewers have viewer demographics, the method further comprising selecting demographic criteria to match viewer demographics, the filtering including identifying queries having demographic information matching the viewer demographics, thereby initiating display of filtered search queries relevant to the viewers.

5. The method of claim 1, wherein the filtering criteria include search queries previously entered by users and the filtering includes discarding previously entered search queries.

6. The method of claim 1, wherein the filtering criteria include number of times a search query is presented.

7. The method of claim 6, wherein the filtering criteria include number of times a search query is presented to therefore identify relatively popular search queries.

8. The method of claim 7, wherein initiating the display includes initiating display of filtered search queries to viewers at an event.

9. The method of claim 6, wherein the filtering criteria include a certain website and a number of times a search query is presented, the filtering including identifying relatively popular search results received via the certain website.

10. The method of claim 6, wherein the filtering criteria include demographic criteria and a number of times a search query is presented, the filtering including identifying relatively popular search queries received from users having demographics matching the demographic criteria.

11. A method of providing a display of information on a web page, the method comprising:
receiving search queries from multiple users;
filtering the search queries based on filtering criteria; and
facilitating display of said filtered search queries on the web page.

12. The method of claim 11, wherein the display is an advertisement including display of said filtered search queries.

13. The method of claim 12, wherein the advertisement is on behalf of an advertiser, the method further comprising receiving filtering criteria from the advertiser.

14. A method of claim 12, wherein the advertisement is for a product and the filtering criteria include an association between the product and search queries.

15. A method of claim 12, wherein the advertisement is for a product, the search queries have associated demographic information based on the users from which they are received and the filtering criteria include demographic criteria, the demographic criteria matching potential purchasers of the product.

16. The method of claim 12, wherein the advertisement includes a scrolling list of filtered search queries.

17. The method of claim 11, wherein display of filtered search queries includes display of a filtered search query link, activation of which initiates display of search results corresponding to the filtered search query link.

18. The method of claim 17, wherein initiating display of the filtered search queries includes facilitating display of an advertisement and wherein activation of the link further includes display of advertising content.

19. The method of claim 11, wherein facilitating display of the filtered search queries includes initiating a Flash movie.

20. The method of claim 12, wherein the advertisement further includes a search tool bar.

21. A method for displaying data based on user input, the method comprising:
receiving user input from multiple users via an on-line application;
automatically selecting received user input for display based on filtering criteria; and
facilitating display of data based on the selected user input to users.

22. The method of claim 21, wherein:
the user input is a query entered into a help application;
the selecting includes selecting received user input based on frequency of receipt; and
the facilitating includes initiating display of a frequently received query and a response to the frequently received query to the users.

23. The method of claim 22, wherein the users are in communication via a network.

24. The method of claim 21, wherein the selecting includes disregarding input received from a first user where the first user has previously entered the search query or a similar search query.

25. A client-server system for displaying data based on user input, the system comprising:
a first server communicatively coupled to the user interface, the first server configured to select received user input for display based on first filtering criteria; and
visual display server configured to initiate display of data based on the selected user input.

26. The system of claim 25, further comprising:
a second server communicatively coupled to the first server, the second server configured to select received user input for display based on second filtering criteria.

27. The system of claim 25, wherein the visual display server is further configured to initiate display of user input via a web page.

28. The system of claim 25, wherein the visual display server is further configured to initiate display of user input via a Flash movie.

29. The system of claim 25, wherein the user input is search queries.

30. The system of claim 25, wherein the display of data is display of an advertisement.

31. A system for display data based on user input, the system comprising:
one or more processors configured to:
receive user input from multiple users via a network;
select received user input for display based on one or more filtering criteria; and
facilitate display of data based on the selected user input to viewers.

32. The system of claim 31, wherein the user input is one or more search queries.

33. The system of claim 32, wherein the one or more filtering criteria include words.

34. The system of claim 32, wherein the search queries have associated demographic information and the one or more filtering criteria include demographic criteria, the one or more processors configured to identify queries having demographic information matching the demographic criteria.

35. The system of claim 32, wherein the filtering criteria include search queries previously entered by users and the one or more processors are configured to discard previously entered search queries.

36. The system of claim 32, wherein the one or more filtering criteria include number of times a search query is received.

37. The system of claim 36, wherein the one or more filtering criteria include number of times a search query is received to therefore identify relatively popular search queries.

38. The system of claim 36, wherein the one or more processors are configured to facilitate display of selected search queries to viewers at an event.

39. The system of claim 36, wherein the filtering criteria include a certain website and number of times a search query is received, the one or more processors configured to identify relatively popular search results received via the certain website.

40. The system of claim 36, wherein the one or more filtering criteria include demographic criteria and a number of times a search query is presented, the one or more processors configured to identify relatively popular search queries received from users having demographics matching the demographic criteria.

41. The system of claim 36, wherein the one or more processors are configured to facilitate display of selected search queries in an advertisement on a web site.

42. The system of claim 41, wherein the advertisement includes a scrolling list of selected search queries.

43. The system of claim 42, wherein the one or more processors are configured to facilitate display of one or more selected search query links, activation of which initiates display of search results corresponding to the activated filtered search query link.

44. The system of claim 43, wherein the activation is accomplished by clicking on the search query link with a mouse controller.

45. A system of displaying data based on user input, the system comprising:
means for receiving user input from multiple users via a network;
means for selecting received user input for display based on one or more filtering criteria; and
means for facilitating display of data based on the selected user input to viewers.

46. A method of providing an advertisement, the method comprising:
providing a feed of search queries, the search queries received from users;
providing advertising content; and
initiating display of the advertisement, the advertisement including a scrolling ticker of search queries of the feed and the advertising content.

47. The method of claim 46, wherein the feed is an XML document.

48. The method of claim 46, wherein the feed is provided in near real time after receiving the search queries.

49. The method of claim 46, wherein the search queries are filtered in accordance with one or more filtering criteria.

50. The method of claim 49, wherein the filtering criteria include words.

51. The method of claim 46, wherein the search queries have associated demographic information and the filtering criteria include demographic criteria, the filtering including identifying queries having demographic information matching the demographic criteria.

52. The method of claim 51, wherein the viewers have viewer demographics, the method further comprising selecting demographic criteria to match viewer demographics, the filtering including identifying queries having demographic information matching the viewer demographics, thereby initiating display of filtered search queries relevant to the viewers.

53. The method of claim 46, wherein the filtering criteria include search queries previously entered by users and the filtering includes discarding previously entered search queries.

54. The method of claim 46, wherein the filtering criteria include number of times a search query is presented.

55. The method of claim 54, wherein the filtering criteria include number of times a search query is presented to therefore identify relatively popular queries.

56. The method of claim 55, wherein initiating the display includes initiating display of filtered search queries to viewers at an event.

57. The method of claim 54, wherein the filtering criteria include a certain website and a number of times a search query is presented, the filtering including identifying relatively popular search results received via the certain website.

58. The method of claim 54, wherein the filtering criteria include demographic criteria and a number of times a search query is presented, the filtering including identifying relatively popular search queries received from users having demographics matching the demographic criteria.

59. The method of claim 46, wherein initiating the display includes incorporating the search queries into a Flash movie clip.

60. The method of claim 46, wherein the scrolling ticker of search queries includes one or more links associated with one or more search queries, respectively, wherein each link is to search results corresponding to the associated search query.

61. The method of claim 46, wherein initiating display of the advertisement includes initiating inclusion of a search window for receiving a new search query in the advertisement.

62. An advertisement for display on a viewing device, comprising:
a portion for containing advertising content; and
a portion for changeably displaying search queries that have been filtered in accordance with predetermined filter criteria.

63. A perceptible, changeable medium comprising:
predetermined perceptible information; and
perceptible, changeable search queries that have been filtered in accordance with filter criteria.

64. The medium of claim 63, wherein the perceptible search queries change over time in accordance with predetermined change criteria.
